(19) United States
(12) Patent Application Publication
(10) Pub. No.: US 2014/0310614 A1
(43) Pub. Date: Oct. 16, 2014

(54) METHOD AND SYSTEM OF INCREASING USER INTERACTION

(71) Applicant: ChaCha Search, Inc, Carmel, IN (US)

(72) Inventor: Scott A Jones, Carmel, IN (US)

(73) Assignee: ChaCha Search, Inc, Carmel, IN (US)

(21) Appl. No.: 14/252,812

(22) Filed: Apr. 15, 2014

Related U.S. Application Data
(60) Provisional application No. 61/811,888, filed on Apr. 15, 2013.
(60) Provisional application No. 61/811,893, filed on Apr. 15, 2013.

(51) Int. Cl. H04L 29/06

(52) U.S. Cl. CPC H04L 65/403
USPC 715/753

(57) ABSTRACT

A system and method for conducting interactive communications between users submitting requests and answerers responding to requests is described which includes simulation of a human responder. When a request is presented a responder may initiate a conversation when a user accepts a request for interaction and a user may be engaged by real time interactions. A user may initiate interactive communication with a responder associated with a responder if a conversation is accepted by a responder.

### BACKGROUND

1. Field of the Invention

The present invention is related to processing of requests and human assisted answering of requests.

2. Description of the Related Art

An amount of time which a user spends interacting with a device and/or system is typically used as a measurement of engagement. This property may be referred to a ‘stickiness’ or ‘persistence’. If a user spends a longer time interacting with items such as a web page, it is presumed that items on that web page or interface will be more likely to draw attention, whether a user is aware of that or not.

Systems which enjoy a high degree of stickiness generally achieve that by including content which is of interest to the user of the system. Examples of this would be the Facebook® web pages, Pinterest® galleries of images, or Instagram® images shared between users. The common property of such systems is that content is presented to a user by a system which attracts the user to interact with the system.

However in the case of a search engine or query response system the content provided is not controlled per se by a search system. In general content presented on a landing interface or query response interface of a search system is information regarding possible documents which might include the information sought by a user submitting a query. In principle every search engine which is keyword driven answers the question “where can I find information about (the query keywords)?” When those responses are returned a user then selects the hyperlinks which provide the content which was scanned to produce a given search result. Activation of a link typically takes a user to a site which is not associated with the search engine, and thus makes the search engine less ‘sticky’ or engaging.

The lack of engagement is made more severe in the case of a system which answers a specific question. For example, if a user query were “How many bowling pins are there in a rack?” an answering system might correctly return an answer such as “There are ten pins in a standard bowling rack.” A user reads a response such as this and may immediately move on to his next activity, thus making the landing page minimally sticky since there is only one answer expected. This problem is quite difficult to solve as populating an answer page with related questions or activities related to bowling may be unlikely to display another question which is of interest to a user.

In some instances a transactional discussion with a person who has responded to a query may be provided to attempt to increase engagement with a user. Forums such as Answers.com, or comment blogs for news articles may provide this sort of functionality. However, the transactional and multi-party nature of such interaction does not invite engagement when an answer is received, but rather when a user returns to an interface provided by the system.

In light of these and other problems, a method and system for increasing user interaction would be greatly appreciated.

### SUMMARY

A system is provided which consists of a user device such as a mobile phone, tablet computer, laptop, desktop, or other network attached device which may submit a request for information. A server is provided to receive requests and route the requests to potential responders. A responder may be an automated or algorithmic answering system, a search engine, and/or may be a system operated by a human person which may include information search capabilities.

When a query or search request or search or question or request is received from a user device, a server may process the query. A server may determine whether a response or answer to a query may be produced automatically. A server may determine whether a human assistant is required to respond to a request. A server may route a query to a human assistant who may provide a response to the request.

If a response is received by a server a user interface may be provided to a user which includes responses provided for the query. If a response was provided in real time by a human assistant or guide an interaction control which allows a user to establish an immediate connection to the guide may be provided. If a user activates an interaction control associated with a response or answer a bidirectional real time communication may be established between the user and the guide or responder. If the responder chooses to decline to interact with a user for a predetermined time period a connection may be terminated. Likewise if a user elects not to activate an interaction control within a predetermined time period the control may be deactivated.

A real time connection may be an exclusive channel between a user and a responder or human assistant. An exclusive conversation may help a user to feel more secure because an interaction is not published as it would be in a forum interaction. A user may be able to return to a previous query or answer to establish a transactional interaction with a responder associated with an answer.

A real time interaction may occur prior to receipt of an answer from a responder. For example, if a request is unclear, or if the request requires additional information for a particular responder to respond, a responder may be permitted to establish a bidirectional interaction with a user. If a user declines to respond a guide may choose not to respond to a query.

A limited duration real time connection to a responder may cause a user to be more likely to remain active on a web page or answer interface because a response is expected from a person who many have broader knowledge about a query topic, because a response is expected to be subjective and interactive discussion is sought with one or more responders and/or for other reasons.

In at least one embodiment if a query receives a stored response and a responder associated with the stored response is available real time interaction may be provided. If a stored answer is provided which is associated with a responder and the responder is not available a user may be provided with an opportunity to interact with another responder associated with a related query. If a user submits a request, a response user interface may be provided. If a stored response is found which is an acceptable match to a request the response may be presented in the user interface in a manner intended to mimic a human responder. For example characters might be presented at a rate which is similar to the ability of a person to enter characters at a keypad or keyboard. Presentation of an answer might be modified to include creation and correction of errors such as spelling or grammar. If a request is ambiguous an automated system response requesting clarification of the request might be presented as originating from a human responder selected to respond to the request. An ambiguous response may be disambiguated by a simulation of a conversation. A response which is not a precise match to a user request is found, the response may be presented using an ‘avatar’ or indicator of a responder. A responder may be selected associated with an avatar if a user responds to an answer associated with an avatar.

Additional aspects and/or advantages will be set forth in part in the description which follows and, in part, will be apparent from the description or may be learned by practice of the invention. These together with other aspects and advantages, which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 illustrates a database for requests.

FIG. 3 illustrates a database for users.

FIG. 4 illustrates a database for responders.

FIG. 5 illustrates a database for resources.

FIG. 6 is a flowchart of processing a request.

FIG. 7 is a flowchart of conducting an interaction.

FIG. 8 is a Graphical User Interface (GUI) for submitting a query.

FIG. 9 is a GUI for selecting a query.

FIG. 10 is a GUI for responding to a query.

FIG. 11 is a GUI for receiving a response to a query.

FIG. 12 is a GUI for conducting a dialogue.

FIG. 13 is a block diagram of an exemplary system embodiment.

FIG. 14 illustrates a database for requests.

FIG. 15 illustrates a database for users.

FIG. 16 illustrates a database for responders.

FIG. 17 illustrates a database for resources.

FIG. 18 is a flowchart of processing a request.

FIG. 19 is a GUI for submitting a query.

FIG. 20 is a GUI for selecting a query.

FIG. 21 is a GUI for responding to a query.

FIG. 22 is a GUI for receiving a response to a query.

FIG. 23 is a GUI for conducting a dialogue.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system or query distribution system or search system or request processing system is provided which includes a user system for submitting a query and receiving a response, a search server receiving the query, a database storing information of queries, search results, searchers, responders, users, resources and other information, a responder system receiving a query and providing a response, and a resource system providing answers and/or other media responsive to a request or query or search request or question.

A system is implemented to allow a user to submit a query and receive a response. A response may include any type of media such as text, URL's, audio, video, etc. A response may be produced automatically and/or using the assistance of a person. A query may be submitted using any suitable device and/or communication service such as SMS, MMS, voice, Instant Messaging, VoIP, internet packet communication, email, etc.

In order to increase user interaction with the system, a user may be given an opportunity to interact with a person providing a response. Similarly, a person providing an answer or “responder” or “answerer” may be able to interact with a person submitting a request. An interactive communication session or “conversation” may be initiated by a user or a responder. An interaction may be initiated by a notification of an intended recipient. If a recipient responds to a notification, a connection may be established. A communication session may be recorded. A conversation may be conducted via voice, text, video, and/or any suitable communication medium. A conversation may be analyzed to determine profile information of a user and/or responder. Any party to a conversation may elect to terminate a conversation.

A request may be directed to any number of responders. Responses may indicate whether a responder is accepting conversations. If a response is provided by an answerer associated with a group, a member of the group may elect to respond to a conversation on behalf of a group. For example, if a member of an organization has responded to a request, if a user receives a stored answer which was produced by a member of the organization and a different member of the organization is available to accept conversations, a user may be able to initiate a conversation with a member of the organization responsive to the answer.

A responder may initiate a conversation with a requester or user. If a responder is uncertain of a request or for any reason, a responder may request to initiate a conversation. If a requester accepts conversation, content of a dialogue or conversation may be shared with other responders who have accepted the request. A time interval may determine whether a conversation is available. For example, if a request has been pending for a period of time, conversations with a person submitting the request may not be available. Likewise, if a response has been available to a request for a period of time, a conversation with a responder may not be permitted.

A layer of processing may consist of automated processing of a query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use. Automated processing of a query which is determined to be factual may be different from automated processing of a query which is determined to be subjective. For example, a match to a subjective query may be less precise than a match to an objective query. Different resources may be used to determine a response to a subjective query than a factual query. If an automated response is associated with a responder, a conversation with a responder may be offered.

A second layer of processing of a query may include a human assistant who analyzes the query or “expediter”. An expediter uses the human ability to recognize context in order to determine a response to a query. An expediter may be provided with relevant context of a query, and offered various options for responding to the query. In its simplest form, an expediter might be presented with a question and two or more options for responding to the question. An expediter may be provided with a rich toolset which provides a greater depth and breadth of responses which may be interactive. In at least one embodiment, an expediter may be provided with responses from a predetermined set of resources. An expediter may be used to determine whether a query is subjective or objective. If a query is determined to be subjective an expediter may not be presented with the query. A conversation may occur between a requester and an expediter.

A third layer of processing of a query may include a human assistant who responds to the query or “searcher”. A searcher or responder or answerer may receive an interpreted query, information of a source of the query, and be provided with resources for performing a search responsive to a query. A searcher may formulate a response based on an interpreted query, and submit the response for delivery to a user responsive to the query. In at least one embodiment, a searcher may receive information of resources which may be used to provide a response, and/or resources which are excluded from providing a response. Selection of a responder for a subjective query may be different than selection of a responder for an objective query. A more general matching may be applied for selection of a responder for a subjective query. An objective query may be directed to a responder based on a type and level of knowledge required to respond to the query. A conversation may occur between a requester and a searcher.

A resource may be characterized according to various parameters. A resource may be evaluated based on a number of responses obtained from and/or using the resource. A resource may be evaluated based on a number of times that a response obtained from the resource is reused. A resource may be evaluated based on an affiliate relationship between a provider of the resource and a provider of search services. A resource may be ranked or evaluated based on a type of response which is to be obtained from the resource. A resource may be ranked based on a category, a topic, a keyword, a level of information provided, a type of information such as objective and/or subjective, etc. If an answer is provided by a resource, a conversation may be offered between a requester and a responder associated with the resource.

As used herein, a “request” means a request for information, products, and/or services. A request or search request or query or question may include various types of media, and may be provided by any user system which may establish communication with a server and/or other devices associated with a search service. A request may be referred to as a “search request”, “search query”, or “query”.

A “user” is a person who submits a request and may receive any type of information responsive to a request. A user may be any person or entity. A “guide” is a person who assists in processing a request. A guide may be referred to as a “provider”, “searcher”, “human searcher”, “responder”, “answerer”, “expediter”, “transcriber”, “specialist” or “generalist”. Guides may be assigned various roles. A guide may be a user. A guide who transcribes a user request from one form to another may be referred to as a transcriber. A guide who reviews a query, determines a most likely response, and may modify a query may be referred to as an expediter or “ambassador”. A guide who performs a search for queries associated with a specific category may be referred to as a specialist. A guide who performs a search for queries regardless of category may be referred to as a generalist. Any guide may perform any role.

An “advertiser” is any person and/or entity which may provide promotional information or “advertisements” to be delivered to a user. An advertisement may take various forms and/or may include media of any sort which can be delivered to a user device. A “result”, “response”, “answer”, or “search result” is any information which has been determined to be a response to a request. A result may include an advertisement. A result may be any information which is provided as a response to a request. A “resource” or “search resource” may be any source of information which may provide a search result and/or other information. A resource may include a search engine, a web server, a software application, an API, printed media, an RSS feed, streaming media, a web page, a database, etc. A “profile” may be any information associated with a person such as demographic data, geographic data, personality data, affiliations, etc. A result may be an “organic” result which is produced by a search which has no intentional bias applied. A result may be a “sponsored” result which is provided and/or approved by a provider with a commercial interest in the response and/or providing the response to a user based on a request for information associated with the sponsored answer or sponsored result.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, an application, regular mail and/or any other suitable type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, and/or any other communication device might be used to establish a communication session.

Communication between a user, a guide, a resource and/or a search system may include conversion of text to speech and speech to text. Any type of media which can be sent and/or received using a communication system may be part of a communication session. A communication session may be conducted using any or all communication services associated with a user, a guide, a resource, and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, a responder, an advertiser and/or a request may be rated. Rating information may be obtained from a user, a guide, an advertiser and/or an administrator of a search system. Rating information may be used to select a user, a guide, a request, a result, a responder, an advertiser, and/or any item based on information associated with an item indicated in a database. A search service may be compensated by advertising revenue. Advertising and/or content may be delivered to a user and/or a guide using any communication service associated with a user and/or a guide. An advertiser may request and obtain information regarding usage, users, demographics, affiliations, etc. associated with queries, keywords, categories, resources etc. and may submit sponsored answers and associate sponsored answers with queries based on information provided.

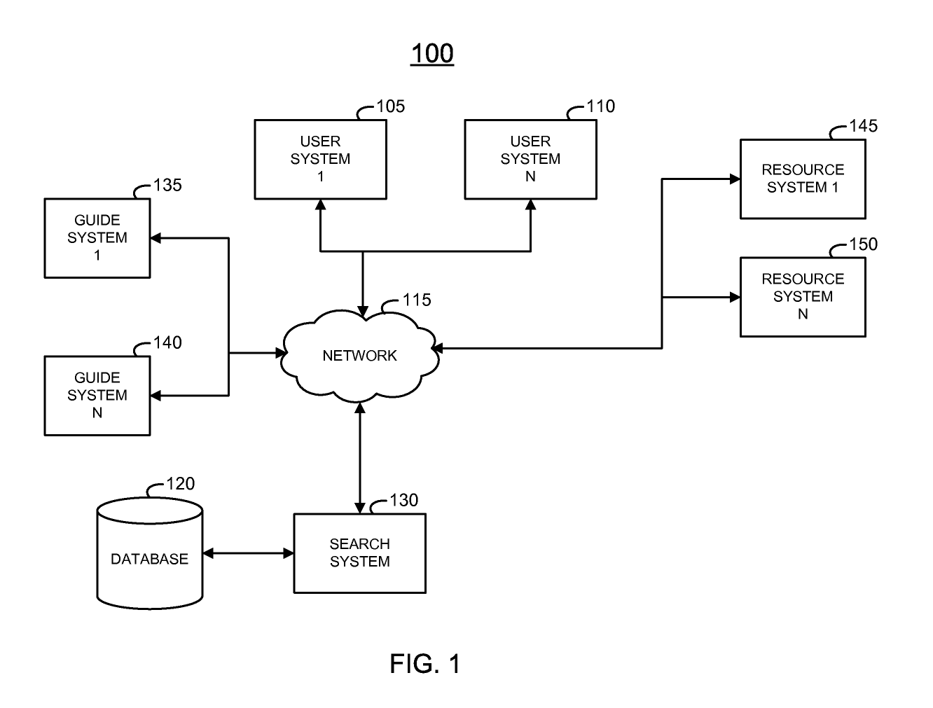

As illustrated in FIG. 1, system 100 includes user systems 105, 110, a network 115 such as the Internet, a search system 130, a database 120, which may comprise various records, guide systems 135, 140, and resource systems 145, 150.

While only a few systems associated with a user, a resource, and a guide or responder are depicted in FIG. 1 it is within the scope of the disclosure for multiple systems for a user, resource, responder and guide to be utilized. In particular it is envisioned that many user, resource and guide systems may be implemented. The search system 130 may be a composed of many components as described further herein.

Any user system (e.g. the user system 105) can be used, to submit a request to the search system 130 and/or receive a result and/or other information. Any user system may receive and/or provide a response, and/or may provide compensation to the search system 130.

The network 115 may be a global public network of networks (i.e., the Internet) and/or may consist in whole or in part of one or more private networks and communicatively couples the user systems 105, 110, the guide systems 135, 140, and the resource systems 145, 150 with the other components of the system such as the search system 130, and the database 120. The network 115 may include one or more wireless networks which may enable wireless communication between the various elements of the system 100. For example, the search system 130 may receive messages which may be routed via a wireless network controlled by a wireless service to the user systems 105, 110. A wireless service may receive messages from the guide systems 135, 140 via a wireless network which is a part of the network 115, and provide the messages to the search system 130 via an internet connection which is part of the network 115. Similarly a voice communication via wired and/or wireless communication might be established between any elements of the system 100.

The search system 130 allows interaction to occur among the user systems 105, 110, the guide systems 135, 140, and the resource systems 145, 150. For example, a request can be transmitted from the user system 105 to the search system 130, which may provide information obtained from the database 120, which may include an advertisement to the user system 105. Similarly, a search result from an answerer operating the guide system 135 and/or the resource system 145 might be routed to the search system 130, which might process the search result, formulate a response and provide a message to the user system 105. Any type of communication between users, resources and/or guides may be mediated and/or facilitated by the search system 130, and/or other elements of the system 100.

The search system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or the entirety of the database 120.

The user systems 105, 110, the guide systems 135, 140, the resource systems 145, 150 and the search system 130 may include equipment, software, systems and personnel required to send and/or receive messages between a user system 105, 110, the guide systems 135, 140, the resource systems 145, 150 and/or the search system 130 using the network 115. The database 120 includes information which may allow the search system 130 to establish communication between any or all of the elements of the system 100.

A user system, a guide system, and/or a search system may be a desktop, portable, or tablet PC or Mac®, a mobile phone, a smart phone, a PDA, a server system, a landline phone, a specialized communication terminal, a terminal connected to a mainframe, or any other communication hardware and/or system. The search system 130 may include one or more servers, computers, etc. For example, servers such as the PowerEdge® 2900 by Dell, or the BladeCenterJS22 by IBM, or equivalent systems might be used to implement elements of the search system 130. The search system 130 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems, resource systems and/or to implement the search system 130.

A user may be identified by the search system 130. When a user system, such as the user system 105, establishes a communication session with the search system 130, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 105 and a resource system, a guide system, a sponsor system and/or the search system 130. Information such as a keyword, a category, a user profile, a request, a result, etc., may be associated with a user. A user may be required to provide profile information to the search system 130. A user may elect to receive requests from the search system 130. Parameters and/or attributes may be associated with a resource as will be further described herein below. Information of a user may be stored in the database 120.

A guide or answerer may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of the guide system 135 in order to communicate with the search system 130. Multiple communication services may be associated with a guide and may allow a communication session to be established between a guide system such as the guide system 135 and a user system, a resource system, a sponsor system, and/or the search system 130. Multiple identifiers of a guide may be associated with each other. Information such as IM credentials, an email address, a phone number, a URL, a username, etc., of a guide may be identified which may allow the search system 130 to establish a communication session between a guide system and a user system, a resource system, a sponsor system and/or the search system 130.

When a guide registers with the search system 130 the guide may be associated with one or more keywords, categories, profiles, and/or other information. Information associated with a guide may be stored in the database 120 and may be used for various purposes. Information associated with a guide may be used to rank requests, resources, results, advertisements, sponsors and/or other information which may be presented to the guide. In at least one embodiment, payment information is associated with a guide. In at least one embodiment, a guide may be required to undergo testing to determine whether a guide is able to perform any tasks which may be required by the search system 130. For example, a guide may be assigned to a role such as translator, transcriber, expediter, generalist, specialist, auditor, etc. A guide may be registered by a sponsor. A sponsor may provide compensation to a sponsored guide. A sponsor may designate personnel associated with the sponsor as responders.

Records may be maintained in the database 120 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein.

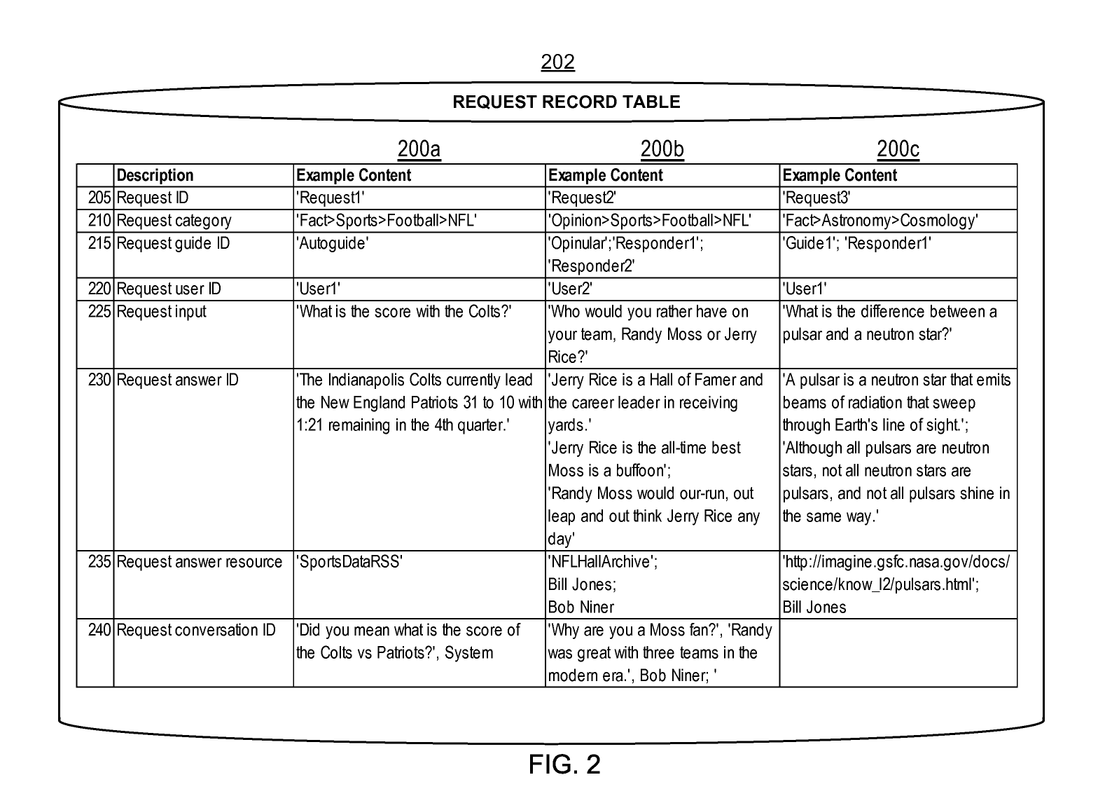

As illustrated in FIG. 2 an exemplary request record table 202 which may comprise a number of request records is provided. One or more request records may be associated with or resident in the database 120 (FIG. 1). The request record table 202 may include information of requests which may be processed. The request records 200 may include a request ID field 205, a request category field 210, a request guide ID field 215, a request user ID field 220, a request input field 225, a request answer ID field 230, a request answer resource field 235, and a request conversation ID field 240.

The request ID field 205 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 205. In at least one embodiment, a random number is indicated in the request ID field 205. Using the example in FIG. 2, ‘Request1’ is the request ID associated with the request record 200a.

The request category field 210 may include information of a category associated with a request. Information indicated in the request category field 210 may be used to select an item associated with a request. For example, a category associated with a request may be used to rank responders who may be associated with the type of request. Likewise, a category associated with a request may be used to rank requests which may be presented to a guide. A category associated with a request may be determined based on factors such as keywords of a query, a profile of a user, a selection of a guide, a user history, an action of a user, an action of a responder, etc. A category associated with a system taxonomy may be indicated in the request category field 210. A category may be associated with a request automatically and/or using the assistance of a person. Using the example in Fig. example in FIG. 2, ‘Request2’ may be categorized as ‘Opinion>Sports>Football>NFL’ as indicated in the request record 200b. This may indicate that a person or item associated with the category ‘Opinion>Sports>Football>NFL’ may have a higher ranking for responding to ‘Request2’. A category of a request may be associated with a user submitting the request. Content of a request such as a keyword, named entity, etc. may be used to assign a category or type to a request. A classification as subjective or objective may be required in order that request may be submitted.

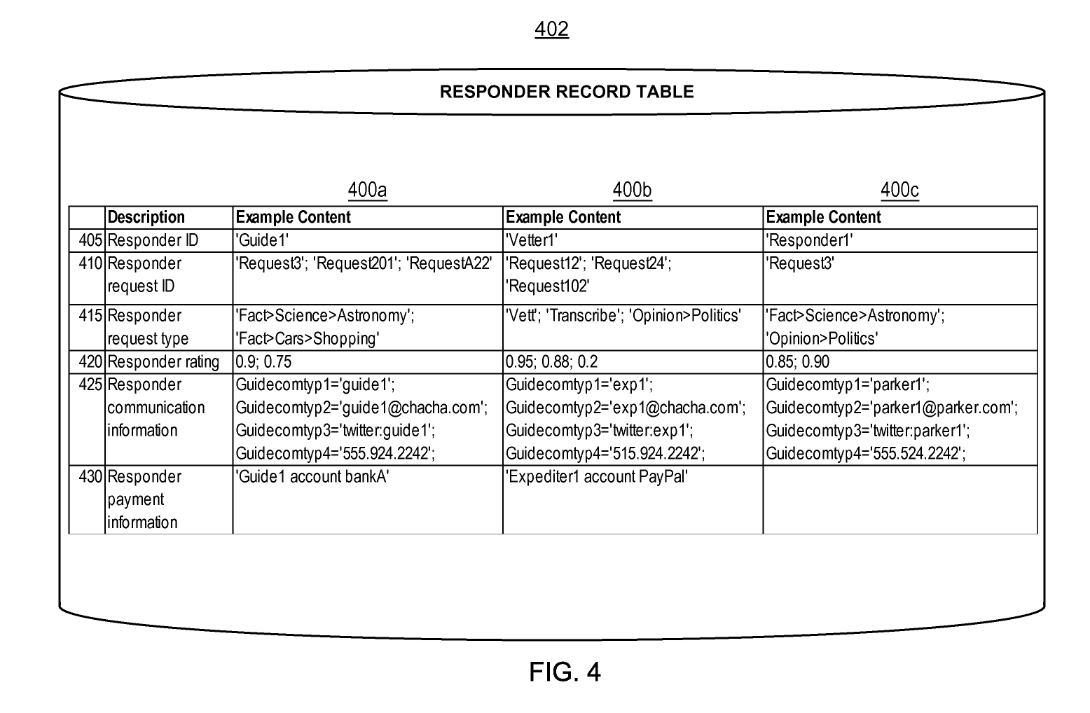

The request guide ID field 215 may include information of a number of guides associated with a request. Content of the request guide ID field 215 may be used to obtain information of a guide using a record such as the responder record 400b (FIG. 4). If a person is selected for a request, elects to receive a request, provides a response to a request, reviews a result of a request and/or completes a request, an identifier of the person may be indicated in the request guide ID field 215. Using the example in FIG. 2, ‘Opinular’, ‘Responder1’ and ‘Responder2’ are associated with ‘Request2’. This may for example indicate that ‘Request2’ has received an automated response from ‘Opinular’ and a response from ‘Responder1’ and ‘Responder2’.

The request user ID field 220 may include information of a number of users associated with a request. Content of the request user ID field 220 may be used to obtain information of a user associated with a request. For example, if a request is submitted by a user, an identifier of the user may be indicated in the request user ID field 220. A request may not be associated with a user request. For example, the search system 130 (FIG. 1) may provide requests to persons which are not directly related to a user request. The search system 130 may provide a request to a responder based on a selection of the request by a user, a responder, an advertiser, etc. Using the example in FIG. 2, ‘User1’ is associated with ‘Request1’ and ‘User2’ is associated with ‘Request2’. This may indicate that ‘Request1’ was submitted by ‘User1’ while ‘Request2’ was submitted by ‘User2’.

The request input field 225 may include information of a request. Content of the request input field 225 may be provided to a person who accepts a request. Content of the request input field 225 may include any type of information. For example, a pointer to audio, video, text, and/or other media may be indicated in the request input field 225. As illustrated in FIG. 2, the query ‘What is the difference between a pulsar and a neutron star?’ is the request input associated with ‘Request3’, as indicated in the request record 200c. In at least one embodiment, the request input field 225 may indicate an original user request, a categorization, and a rewritten user request.

The request answer ID field 230 may include information of a response associated with a request. Content of the request answer ID field 230 may be provided responsive to a request. Content of the request answer ID field 230 may be stored in the database 120 (FIG. 1). Content of the request answer ID field 230 may be reviewed and/or rated by a user, a guide, an answerer and/or an administrator. As illustrated in FIG. 2, the responses ‘A pulsar is a neutron star that emits beams of radiation that sweep through Earth's line of sight.’, and ‘Although all pulsars are neutron stars, not all neutron stars are pulsars, and not all pulsars shine in the same way.’ are associated with ‘Request3’ as illustrated in the request record 200c. While a text response to a query is used for the purposes of illustration, any type of media may be indicated in the request answer ID field 230. In at least one embodiment, a text response and a URL associated with a source of the text response may be indicated in the request answer field 230. In at least one embodiment, a responder may select a response which may cause a URL associated with the response may be inserted in the request answer resource field 235.

The request answer resource field 235 may include information of a resource associated with a request. Content of the request answer resource field 235 may be used for various purposes. A URL associated with a response may be used to determine whether a response is reliable. As illustrated in FIG. 2, a URL associated with an RSS feed is associated with ‘Request1’ which may indicate that a response associated with ‘Request1’ must be treated according to a pre-determined set of rules. For example, an opinion-type response associated with a particular responder may be more likely to be reused based on a rating of the responder. For example, if a user votes a response of a responder as positive a future response of the responder which is associated with a category of the response may be more likely to be presented. A response to a subjective request may be obtained from a resource such as the resource ‘NFLHallArchive’ indicated in the request answer resource field 235. If a response is not received from a responder within a predetermined time period of receipt of a request a response extracted from a resource may be provided. Likewise if less than a pre-determined number of responses is returned a response obtained from a resource may be provided. For example, a snippet including a named entity indicated in a user request may be extracted from a resource, which snippet may be provided responsive to a request. Using the example in FIG. 2, the sentence ‘Jerry Rice is a Hall of Famer and the career leader in receiving yards.’ Might be extracted from ‘NFLHallArchive’ based on the presence of the named entity ‘Jerry Rice’. As the query is subjective, the response may be accepted or relevant despite not being a direct answer to the user query.

The request conversation ID field 240 may include information of a conversation associated with a request. A conversation may be initiated automatically. As illustrated in the Request record 200a, if a query is an incomplete match to a stored query, a system response may appear as a conversation request from an alias. As indicated in the request record 200b, the request conversation ID field 240 may include a response of a responder and an identifier of a responder. Any number of conversations associated with a request may be indicated in the request conversation ID field 240.

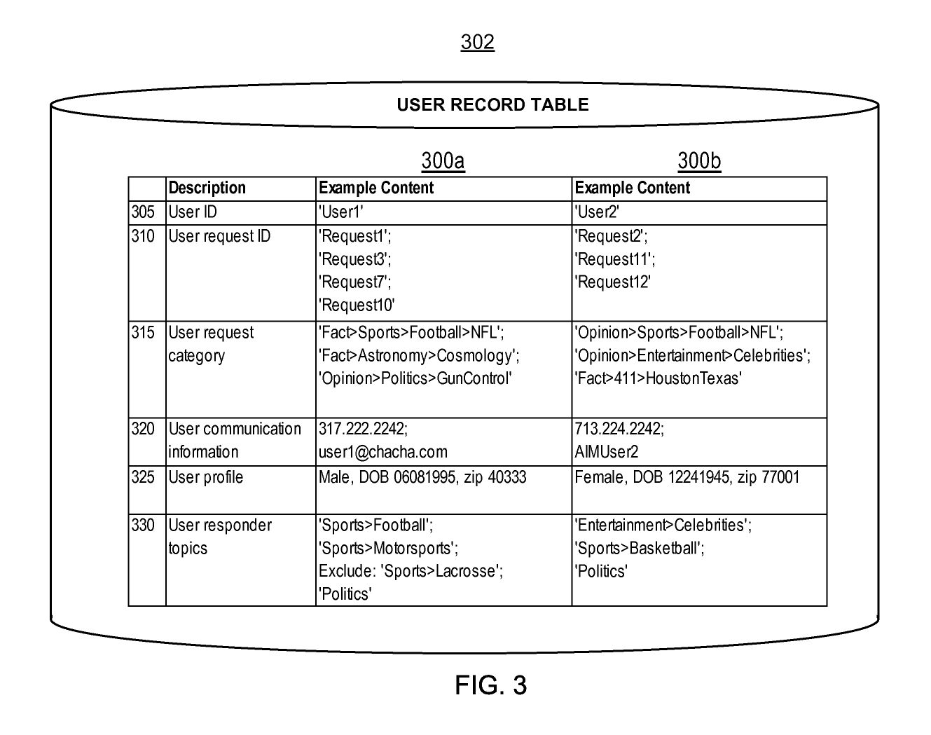

As illustrated in FIG. 3 an exemplary user record table 302, which may comprise a number of user records is provided. One or more user records may be associated with or resident in the database 120 (FIG. 1). The user record table 302 may include information of users. The user records 300 may include a user ID field 305, a user request ID field 310, a user request category field 315, a user communication information field 320, a user profile field 325, and a user responder topics field 330.

The user ID field 305 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 305. Using the example in FIG. 3, ‘User1’ is the user ID associated with the user record 300a.

The user request ID field 310 may include information of a number of requests associated with a user. A user request ID may be for example a pointer to a request record associated with a request submitted by a user. If a user submits a request, a request ID may be added to the user request ID field 310. Using the example illustrated in FIG. 3, ‘Request2’, ‘Request11’ and ‘Request12’ are associated with ‘User2’ as indicated in the user record 300b. This may indicate that ‘User2’ has submitted ‘Request2’, ‘Request11’ and ‘Request12’.

The user request category field 315 may include information regarding a category or type associated with a user request. For example, if a request is directed to a type of processing or a category, etc. a type and/or category associated with the processing may be indicated in the user request category field 315. In at least one embodiment, the user request ID field 310 and the user request category field 315 are linked by for example a pointer. In at least one embodiment, a user may be restricted to submitting questions which are subjective or objective type questions. A user may be restricted to accepting requests which are subjective or objective. Content of the user request category field 315 may be used to determine categories of queries which may be directed to a guide, a user and/or a resource. Content of the user request category field 315 may be used to rank resources, guides, advertisements, resources, etc. and may affect a probability that an item will be presented to a user, guide or responder.

The user communication information field 320 may include information of a number of communication services associated with a user. Any information which may be used to establish communication with a user may be indicated in the user communication information field 320. For example, a telephone number, an email address, an IM credential, a URL, a username, a password, and/or other communication information may be indicated in the user communication information field 320. Using the example in FIG. 3, the phone number ‘317.222.2242’ and the email ‘user1@chacha.com’ are associated with ‘User1’.

The user profile field 325 may include information of a profile associated with a user. For example, demographic, geographic, affiliation, personality, and/or other types of anthropic and/or other characteristic information may be associated with a user. A user may provide profile information as part of a registration process. User profile information may be obtained from a database provided by a third party. User profile information may be determined based on test, polling, query history, peer review, and/or other information associated with a user. Using the example illustrated in FIG. 3, ‘Female, DOB 12241945, zip 77001’ are associated with ‘User2’. Profile information may be used to match information provided by a user to other information. For example, a ranking of a guide for a query of a user may be adjusted based on a profile associated with the user. An answer might be modified based on geographic, demographic, etc. profile information of a user. A responder, guide and/or resource might have a different rating and/or ranking based on profile information of a user.

The user responder topics field 330 may include information of topics associated with a user for which the user may be selected as a responder. The user responder topics field 330 may include topics for which a user has elected to receive questions and/or topics for which a user has requested not to receive questions. Content of the user responder topics field 330 may be used to rate a user for a request. As illustrated in FIG. 3, a query associated with ‘Politics’ or ‘Sports’ might be directed to ‘User1’ and ‘User2’, but if the query is associated with ‘Sports>Lacrosse’‘User1’ would not receive the query. A user may elect to receive subjective and/or objective requests associated with a category.

As illustrated in FIG. 4 an exemplary responder record table 402 which may comprise a number of responder records is provided. One or more responder records may be associated with or resident in the database 120 (FIG. 1). The responder record table 402 (FIG. 4) may include information of responders. The responder records 400 may include a responder ID field 405, a responder request ID field 410, a responder request type field 415, a responder rating field 420, a responder communication information field 425, and a responder payment information field 430.

The responder ID field 405 includes an identifier of a responder which is preferably unique and is preferably used consistently. A responder ID serves to distinguish a responder record associated with a responder from a responder record associated with other responders. Any number of characters, numbers, and/or other indicators may be used to indicate a responder ID. In at least one embodiment, a random number is indicated in the responder ID field 405. In at least one embodiment, a pseudonym selected by a responder may be indicated in the responder ID field 405. A first and last name of a responder may be indicated in the responder ID field 405. Using the example in FIG. 4, ‘Guide1’ is the responder ID associated with the responder record 400a.

The responder request ID field 410 may include information of a number of requests associated with a responder. Content of the responder request ID field 410 may be used to obtain information of a request. For example, if a user request has been determined to require a number of requests to be performed, the search system 130 (FIG. 1) may assign a unique ID to the requests and may distribute information of the requests to responders. Using the example in FIG. 4, ‘Vetter1’ is associated with ‘Request12’, ‘Request24’ and ‘Request102’ as indicated in the responder record 400b. This may indicate that ‘Vetter1’ has responded to those requests by for example classifying, transcribing, clarifying, etc.

The responder request type field 415 may include information of a number of types of requests which may be processed by a responder. For example, a category and/or keyword associated with a request, a type of request, temporal information associated with a request, etc., which may be used to determine if a responder is to be presented with a request may be indicated in the responder request type field 415. In at least one embodiment, a responder may be assigned to a particular type of request as part of a registration process. A responder may select a type of request which the responder may perform. A responder may be required to pass a test in order to be associated with a type of request. For example if a responder is to provide responses to factual queries, an assessment of a responder's knowledge of a topic may be performed. A responder may be assigned to a role such as vetter, expediter, searcher, etc., which may be indicated in the responder request type field 415. A request indicating a keyword may be directed to a responder. Using the example in FIG. 4, ‘Responder1’ is associated with ‘Fact>Science>Astronomy’ and ‘Opinion>Politics’ as indicated in the responder record 400c. This may for example indicate that ‘Responder1’ may be presented with and/or selected to respond to requests indicating those classifications.

The responder rating field 420 may include information of a number of ratings associated with a responder. For example, quality, speed, peer review, etc., may be used to determine a rating of a responder. A rating of a responder may be used for purposes such as determining compensation for the responder (e.g. bonus points), selecting a responder to respond to a request, matching a request to a responder, etc. In at least one embodiment, the responder request type field 415 and the responder rating field 420 may be linked by, for example, a pointer. Using the example in FIG. 4, ‘Guide1’ and ‘Responder1’ are associated with the type ‘Fact>Science>Astronomy’ and ‘Vetter1’ and ‘Responder2’ are associated with the type ‘Opinion>Politics’. A response associated with ‘Guide1’ may be more likely to be provided responsive to a request associated with ‘Fact>Science>Astronomy’, while ‘Responder1’ might be more likely to be provided with an opportunity to respond to a request associated with ‘Opinion>Politics’ based on the ratings indicated in the responder rating field 420.

The responder communication information field 425 may include information of a number of communication services associated with a responder. For example, a user name and password, an email address, an IM credential, a phone number, a web page, a physical address, etc., may be indicated in the responder communication information field 425. Using the example illustrated in FIG. 4, ‘Guide1’ is associated with the login ID ‘guide1’, the email ‘guide1@chacha.com’, the Twitter account ‘twitter.guide1’, and the phone number ‘555.924.2242’. This may indicated that ‘Guide1’ may be contacted using the associated communication services.

The responder payment information field 430 may include information of a payment method associated with a responder. For example, banking information, a PayPal® account, a Western Union® account, etc., may be indicated in the responder payment information field 430. Content of the responder payment information field 430 may be used to provide compensation to a responder. For example, payment may be made by Automated Clearing House (ACH), wire transfer, etc., using information indicated in the responder payment information field 430. If a responder is not compensated, the responder payment information field 430 may be blank.

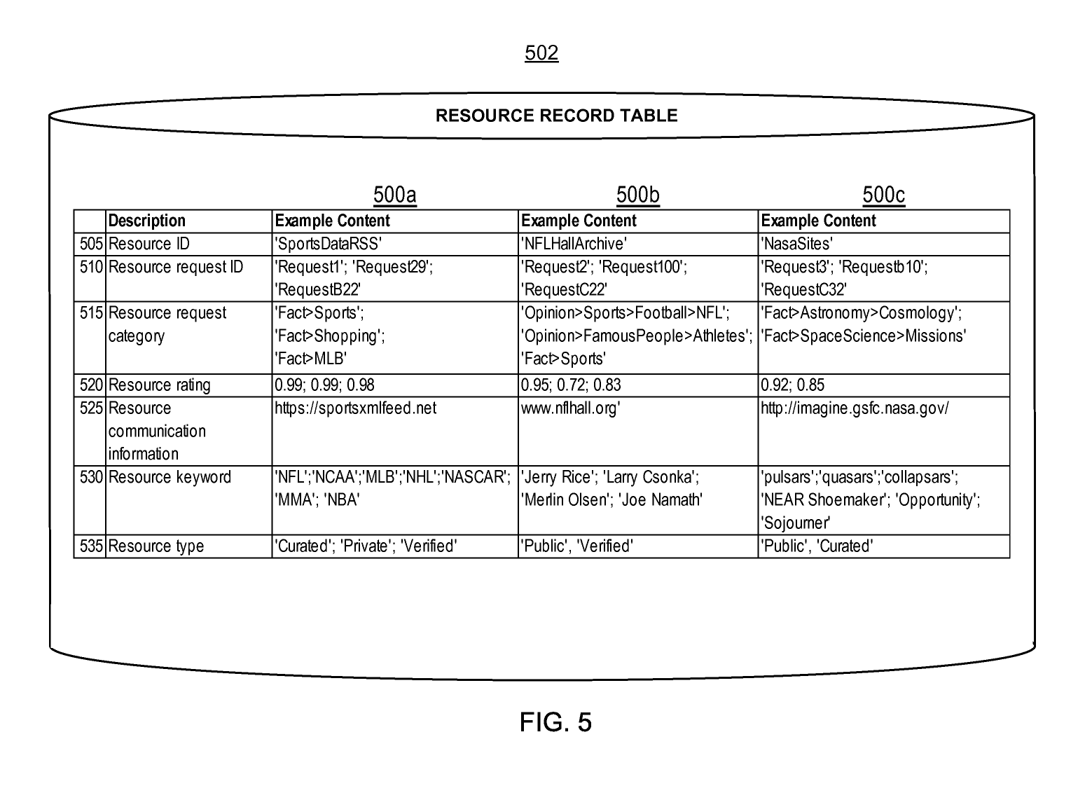

As illustrated in FIG. 5 an exemplary resource record table 502 which may comprise a number of resource records is provided. One or more resource records may be associated with or resident in the database 120 (FIG. 1) is provided. The resource record table 502 (FIG. 5) may include information of resources. The resource records 500 may include a resource ID field 505, a resource request ID field 510, a resource request category field 515, a resource rating field 520, a resource communication information field 525, a resource keyword field 530, and a resource type field 535.

The resource ID field 505 includes an identifier of a resource which is preferably unique and is preferably used consistently. A resource ID serves to distinguish a resource record associated with a resource from a resource record associated with other resources. Any number of characters, numbers, and/or other indicators may be used to indicate a resource ID. Using the example in FIG. 5, ‘SportsDataRSS’ is the resource ID associated with the resource record 500a. This may indicate that ‘SportsDataRSS’ has been used to produce a search result, and is accessible to a guide, but may not be accessible to a user.

The resource request ID field 510 may include information of a number of requests associated with a resource. Content of the resource request ID field 510 may be used to obtain information of a request. For example, if a resource has been used to respond to a request, an identifier of the request may be indicated in the resource request ID field 510. Using the example in FIG. 5, ‘Request2’, ‘Request100’ and ‘RequestC22’ are associated with the resource ‘NFLHallArchive’ as indicated in the resource record 500b. This may indicate that ‘NFLHallArchive’ has been utilized to respond to ‘Request2’, ‘Request100’ and ‘RequestC22’.

The resource request category field 515 may include information of a number of categories of requests which may be processed by a resource. For example, a category and/or keyword associated with a request, a type of request, profile, etc., which may be used to determine if a resource and/or a result obtained from a resource is to be presented to a responder for a request may be indicated in the resource request category field 515. In at least one embodiment, a resource may be assigned to a category of request as part of a registration process. A resource may be associated with a user, a group of users, an access right, an advertiser or sponsor, etc. A provider of a resource may select a type and/or category of request for which the resource may be used and/or required. A resource may be associated with a category based on a selection by an administrator, based on success rates of obtaining or providing answers, etc. Using the example in FIG. 5, NASASites' is associated with the category ‘Fact>Astronomy>Cosmology’ and ‘Fact>SpaceScience>Missions’ as indicated by the resource record 500c.

The resource rating field 520 may include information of a number of ratings associated with a resource. For example, a rating of a resource may be based on ratings of answers produced using the resource, a contractual agreement, an affiliation, temporal information such as time spent by guides, etc. A rating of a resource may be used to select a resource which is provided to a searcher or guide, to rank a response associated with a resource, etc. In at least one embodiment, the resource request category field 515 and the resource rating field 520 may be linked by, for example, a pointer. Using the example in FIG. 5, ‘SportsDataRSS’ has a rating of ‘0.99’ associated with ‘Fact>Sports’, and ‘NFLHallArchive’ has a rating ‘0.83’, associated with “Fact>Sports’ which may for example indicate that ‘SportsDataRSS’ is more likely to produce an acceptable response for that category. A resource may have a rating corresponding to various categories, types of information, types of tasks, keywords, etc.

The resource communication information field 525 may include information of a number of communication services associated with a resource. For example, a user name and password, an email address, an IM credential, a phone number, a web page, a physical address, etc., may be indicated in the resource communication information field 525. A communication service indicated in the resource communication information field 525 may for example be used to indicate a service by which a resource may be accessed. Using the example illustrated in FIG. 5, the URL <<‘https://sportsxmlfeed.net>> is associated with ‘SportsDataRSS’. This may indicate that a query associated with ‘Fact>Sports’ may be submitted to that URL by for example an API.

The resource keyword field 530 may include information of a number of keywords associated with a resource. A match to a keyword indicated in the resource keyword field 530 may affect a probability that a request will receive a response associated with a resource. For example, a match may prohibit a query from receiving a result from a resource, may increase a ranking of a resource, may be used to associate a category with a request, may identify a resource to be provided to a guide, responder, vetter, etc. In at least one embodiment, keywords included in requests for which a resource has provided an answer may be more highly ranked for a category associated with the query and the resource.

The resource type field 535 may include information of a number of types or characteristics associated with a resource. A type may include an indication of an access right, a commercial arrangement, a preference, quality of content, source of content, etc. A searcher may elect to associate a resource with a type. A system administrator may associate a type with a resource. A provider of a resource may designate a type associated with the resource as part of a registration process. Using the example in FIG. 5, ‘SportsDataRSS’ is a ‘Verified’, ‘Private’, ‘Curated’ resource. This may indicate that content of the resource is controlled, that the resource is not accessible to the general public, and that the content of the resource is verified to be correct.

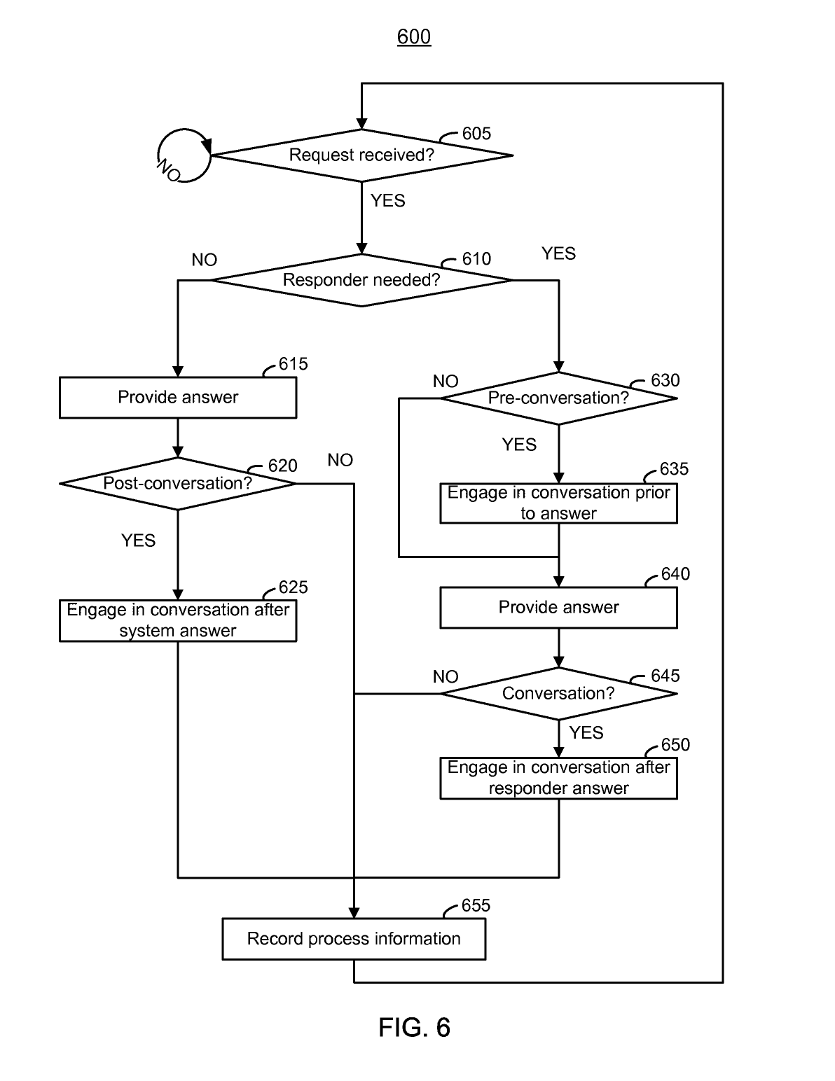

As illustrated in FIG. 6, a process 600 for providing an answer is provided. The process 600 may be performed in whole or in part by any suitable element of the system 100 (FIG. 1). In at least one embodiment, the process 600 is operative on a server associated with the search system 130. A request may be a request for an automated answer, a human assisted answer and/or a combination thereof.

In operation 605 (FIG. 6) a determination is made as to whether a request is received. If it is determined in operation 605 that a request is not received, control remains at operation 605 and process 600 continues. If it is determined in operation 605 that a request is received, control is passed to operation 610 and process 600 continues.

The determination in operation 605 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. If a message is received at a server associated with the search system 130, it may be determined that a request is received.

In operation 610 a determination is made as to whether a responder is needed. If it is determined in operation 610 that a responder is not needed, control is passed to operation 615 and process 600 continues. If it is determined in operation 610 that a responder is needed, control is passed to operation 630 and process 600 continues.

The determination in operation 610 may be made based on various criteria. If an automated response is found, it may be determined that a responder is not needed. If a user request is subjective, it may be determined that a responder is or is not needed. If a request is ambiguous, it may be determined that a responder is needed. Any suitable criteria may be used to determine whether a responder is needed.

In operation 615, an answer is provided. Any number of answers may be provided. If an answer is provided based on stored information an indication may be provided to a requester that a conversation is available based on a status of a person associated with the answer. Control is passed to operation 620 and process 600 continues.

In operation 620 a determination is made as to whether a post-conversation is initiated. If it is determined in operation 620 that a post-conversation is not initiated, control is passed to operation 655 and process 600 continues. If it is determined in operation 620 that a post-conversation is initiated, control is passed to operation 625 and process 600 continues.

The determination in operation 620 may be made based on various criteria. A user may activate a control indicating that a conversation is desired. A responder may be notified that an answer has been viewed, which may allow a responder to initiate a conversation. If a responder associated with an answer is not available, a conversation may be initiated with a different responder linked to the original responder. Any suitable criteria may be used to determine whether a post-conversation is initiated.

In operation 625, a conversation after a system answer is engaged. A system answer may allow a user and a responder who has provided a response to engage in a conversation. A system answer may allow a user to initiate a conversation with a guide. A system answer may allow a requester to interact with a responder associated with an answer that is provided by an advertiser or vendor which has sponsored an answer. For example, a person associated with a sponsored answer who is not an original answer may be made available for a conversation. Control is passed to operation 655 and process 600 continues.

In operation 630 a determination is made as to whether a pre-conversation occurs. If it is determined in operation 630 that a pre-conversation does not occur, control is passed to operation 640 and process 600 continues. If it is determined in operation 630 that pre-conversation occurs, control is passed to operation 635 and process 600 continues.

The determination in operation 630 may be made based on various criteria. If a request is found to be ambiguous it may be determined that a pre-conversation occurs. If a responder requests a conversation with a requester, it may be determined that a pre-conversation occurs. If a guide determines that a request is unclear, it may be determined that a pre-conversation occurs. If a responder associated with a category or type associated with a request is available, it may be determined that a pre-conversation occurs. Any suitable criteria may be used to determine whether a pre-conversation occurs.

In operation 635, a conversation prior to an answer is engaged. A conversation prior to an answer or pre-conversation may occur between a requester and any number of responders. A conversation prior to an answer may include any type of communication between a requester and a responder. Control is passed to operation 640 and process 600 continues.

In operation 640, an answer is provided. An answer may be a response of a number of responders. An answer may be an automated response. An answer may include an advertisement. An answer may be provided using any communication service associated with a requester. Control is passed to operation 645 and process 600 continues.

In operation 645 a determination is made as to whether a post-conversation occurs. If it is determined in operation 645 that a post-conversation does not occur, control is passed to operation 655 and process 600 continues. If it is determined in operation 645 that post-conversation occurs, control is passed to operation 650 and process 600 continues.

The determination in operation 645 may be made based on various criteria. A conversation subsequent to an answer or post-conversation may occur between a requester and any number of responders. If a requester requests to communicate with a responder associated with a response, it may be determined that a post-conversation occurs. If a responder requests to contact a requester who has received a response, it may be determined that a post-conversation occurs. If a responder is associated with a category of a response and a user accepts to engage in a conversation with the responder, it may be determined that a post-conversation occurs. Any suitable criteria may be used to determine whether a post-conversation occurs.

In operation 650 a conversation after a responder answer is engaged. A conversation after an answer may include a requester and a responder. A conversation after an answer may include a number of responders which may exclude a requester. A conversation after an answer may be a real-time communication and/or may be conducted non real time via any communication service associated with a responder and/or a requester.

In operation 655, process information is recorded. Information of a request, an answer, a category, a keyword, a resource, a user, a guide, a responder, a rating, a ranking, etc. may be recorded. A conversation may be rated, ranked, or deleted. In at least one embodiment, process information is recorded in the database 120 (FIG. 1). Control is passed to operation 605 and process 600 continues.

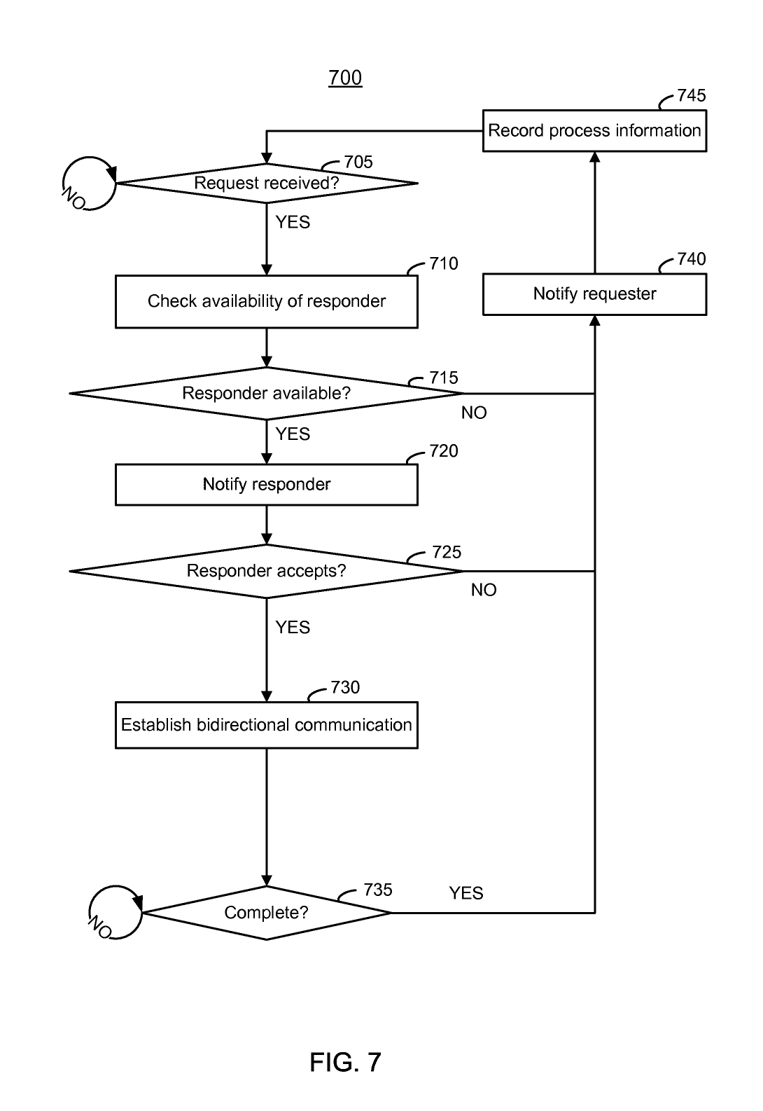

As illustrated in FIG. 7, a process 700 for conducting a conversation is provided. The process 700 may be performed in whole or in part by any suitable element of the system 100 (FIG. 1). In at least one embodiment, the process 700 is operative on a server associated with the search system 130.

In operation 705 (FIG. 7) a determination is made as to whether a conversation request is received. If it is determined in operation 705 that a conversation request is not received, control remains at operation 705 and process 700 continues. If it is determined in operation 705 that a conversation request is received, control is passed to operation 710 and process 700 continues.

The determination in operation 705 may be made using various criteria. In at least one embodiment, if a message is received at a system associated with the search system 130 (FIG. 1), it may be determined that a request is received. For example, if an email message, an SMS, EMS, and/or MMS message, an IM, an IP message, a message from an application and/or a voice message is received at an address associated with the search system 130, it may be determined that a request is received. In at least one embodiment, if a message is received at a server associated with the search system 130, it may be determined that a request is received.

In operation 710 responder availability is checked. If a responder is logged into an application, a responder may be available. If a conversation request is directed to a group a number of members of a group may be notified of a conversation request. If a response is associated with a stored or automated answer or resource, a status of a responder associated with the resource may be obtained. A request and/or reply may be posted to a number of users who may elect to respond based on an action of a user such as a search, browsing, a category of a conversation request, etc. Control is passed to operation 715 and process 700 continues.

In operation 715 a determination is made as to whether a responder is available. If it is determined in operation 715 that a responder is available, control is passed to operation 720 and process 700 continues. If it is determined in operation 715 that a responder is not available, control is passed to operation 720 and process 700 continues.

The determination in operation 715 may be made in various ways. For example, if presence information associated with a responder indicates that the responder is not accepting conversations it may be determined that a responder is not available. If a response to a request to engage in a conversation is not received within a time period, it may be determined that a responder is not available. If a responder has recently provided an answer or engaged in a conversation, it may be determined that a responder is available. If a response is associated with an automated system, it may be determined that a responder is not available. If a response is associated with a responder who is not active, it may be determined that a responder is not available. If a response is associated with a category, type, organization, group, etc. if a responder associated with the category, type, organization, group, etc. is available, it may be determined that a responder is available. Any suitable criteria may be used to determine whether a responder is available.

In operation 720 a responder is notified. A responder may be notified in any suitable manner. Any communication service associated with a responder may be used to notify a responder. For example, a notification in an app, or via a notification functionality of a user device, or a messaging service such as SMS may be provided to a responder. Control is passed to operation 725 and process 700 continues.

In operation 725 a determination is made as to whether a responder accepts a conversation. If it is determined in operation 725 that a responder accepts a conversation, control is passed to operation 730 and process 700 continues. If it is determined in operation 725 that a responder does not accept a conversation, control is passed to operation 740 and process 700 continues.

The determination in operation 725 may be made according to various criteria. If a responder replies to a notification it may be determined that a responder accepts a conversation. If a response to a notification is not received within a time period after a notification, it may be determined that a responder does not accept a conversation. Any suitable criteria may be used to determine whether a responder accepts a conversation.

In operation 730 bidirectional communication is established. Bidirectional communication may occur using various media and/or communication services. In at least one embodiment, an instant messaging connection may be established. Voice communication may be used to establish communication. Any number of messages may be exchanged. Control is passed to operation 735 and process 700 continues.

In operation 735, a determination is made as to whether a conversation is complete. If in operation 735 it is determined that a conversation is not complete, control remains at operation 735 and process 700 continues. If in operation 735 it is determined that a conversation is complete, control is passed to operation 740 and process 700 continues.

The determination in operation 735 may be made based on various criteria. If a responder indicates that a conversation is ended, it may be determined that a conversation is complete. If a requester indicates that a conversation is complete, it may be determined that a conversation is complete. If no messages have been exchanged during a time period, it may be determined that a conversation is complete. Any suitable criteria may be used to determine whether a conversation is complete.

In operation 740 a requester is notified. A requester may be notified of a status of a conversation. For example, if a responder declines a conversation a requester may be notified that a responder has declined a conversation. If a responder is not available, a requester may be notified of a status of a responder, which may indicate whether a responder will be available. A requester may be notified that a conversation is complete. Any status of a conversation request may be provided to a requester. For example, an amount of time before a requester will be available, etc. may be a portion of a notification of a requester. Control is passed to operation 745 and process 700 continues

In operation 745, process information is recorded. Information regarding any item such as a user, a guide, a request, a resource, an advertisement, a responder, keyword, category, etc. may be recorded and/or updated. For example, information of a conversation, participants in a conversation, keywords, temporal information, a resource, etc. associated with a conversation may be stored. A rating of a responder and/or requester may be adjusted based on a conversation. For example, a responder rating may be increased if a responder accepts a conversation, or a user rating may be decreased if a user initiates a conversation, but does not respond to an answerer. In at least one embodiment, process information is recorded in the database 120 (FIG. 1). Control is passed to operation 705 and process 700 continues.

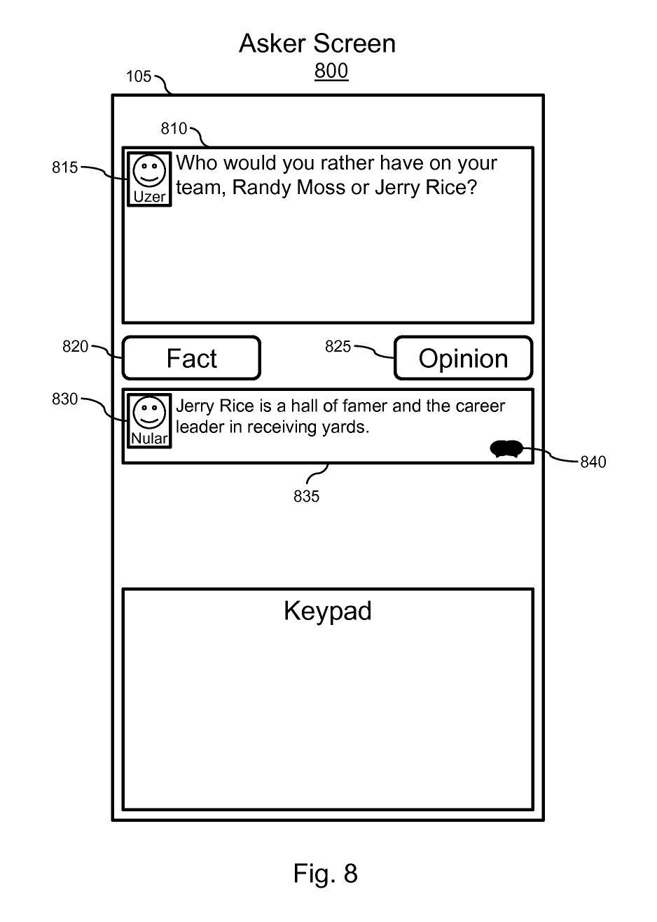

As illustrated in FIG. 8 an exemplary response GUI 800 is provided. The response GUI 800 may be provided to a user. The GUI 800 may be presented using a system such as the user system 105 (FIG. 1). The GUI 800 may be used to provide a response any type of request. The GUI 800 may include a query indicator area 810, a user identifier 815, a factual query indicator 820, an opinion query indicator 825, a responder indicator 830, a response indicator 835, and a conversation indicator 840.

As illustrated in FIG. 8, the query indicator area 810 may include a subjective query which has been submitted. The user identifier 815 may indicate a user associated with a query submitted using the opinion query indicator 825. The fact indicator 820 may be active by default, may be active based on content of a query, may be always active, etc. The responder indicator 830 may indicate a source of a response. As illustrated in FIG. 8, ‘Nular’ which may be an automated system has responded with an answer indicated in the response indicator 835. The conversation indicator 840 may be used to establish a two-way exchange with a responder indicated by the responder indicator 830. If a responder has declined to receive two-way communications, is an automated system, or for any reason the conversation indicator 840 may be inactive as indicated by for example the filled indicator in FIG. 8. Any suitable indicator such as color, shading, etc. may be used to indicate that the conversation indicator 840 is active or inactive.

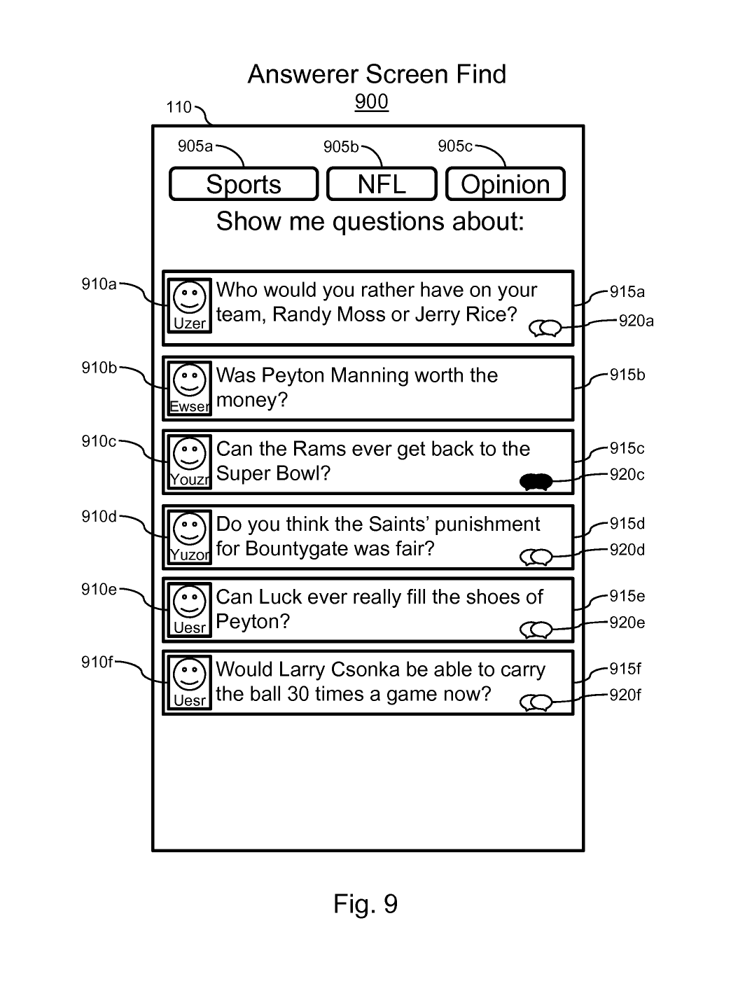

As illustrated in FIG. 9 an exemplary query selection GUI 900 is provided. The GUI 900 may be provided to a user, a responder, a guide, etc. The GUI 900 may be presented using a system such as the user system 110 (FIG. 1). The GUI 900 may be used to obtain information of a query. The GUI 900 may include selection indicators 905a-905c, query indicators 915a-915f, user indicators 910a-910f, and conversation indicators 920a, 920c-920f.

As illustrated in FIG. 9, the category indicators 905a-905c may include a category, type, etc. which may be used to select a query. The category indicator 905a, 905b may indicate that questions regarding ‘Sports’ and ‘NFL’ are desired. The category indicator 905c may indicate that queries classified as ‘Opinion’ are to be provided. The user indicators 910a-910f may indicate information of a user associated with a request. For example, the user indicator 910b shows that ‘Ewser’ has submitted the query ‘Was Peyton Manning worth the money?’ as indicated in the query indicator 915b. The absence of a conversation indicator in the query indicator 915b may indicate that a user submitting the request does not accept conversations. As illustrated in FIG. 9, the conversation indicators 920a, 920c-920f may indicate that a user associated with a request is available for a two-way communication. For example, the conversation indicator 920a may indicate that ‘Uzer’ is available for a real-time exchange of information as indicated by the speech bubbles in the conversation indicator 920a. Any suitable indicator such as color, shading, etc. may be used to indicate status of the conversation indicators 920a, 920c-920f. A responder may be notified of requests associated with topics for which a responder has registered using a GUI such as the GUI 900.

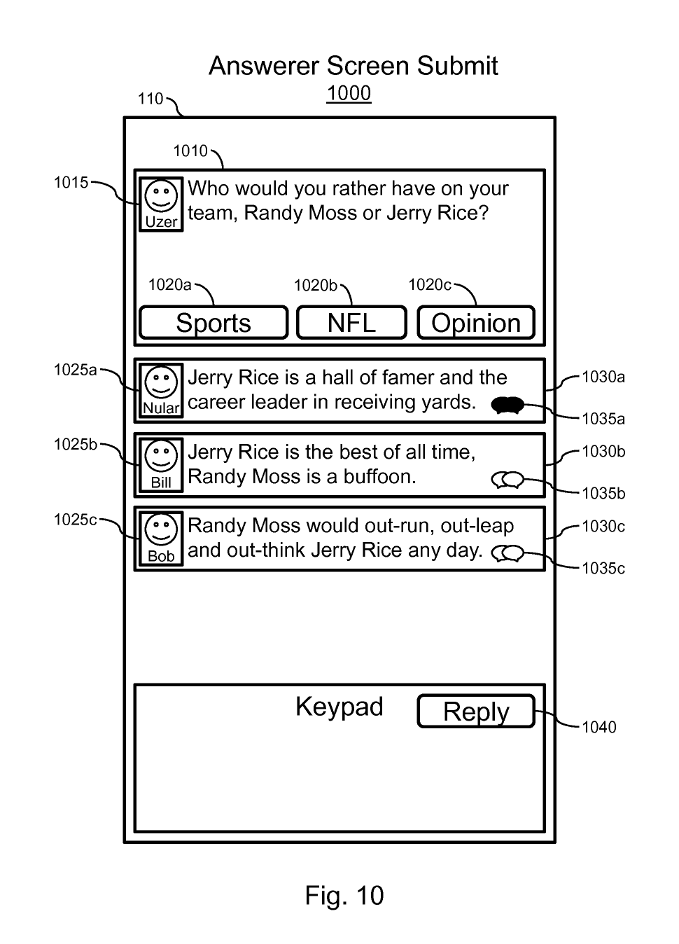

An exemplary GUI 1000 for responding to a question is illustrated in FIG. 10. The GUI 1000 may be presented on a device such as the user system 105 (FIG. 1). The GUI 1000 may include a query indicator 1010, a user indicator 1015, category indicators 1020a-1020c, responder indicators 1025a-1025c, response indicators 1030a-1030c, responder conversation indicators 1035a-1035c and action control 1040.

The query indicator 1010 may be used to indicate a query to which responses are to be provided. The user indicator 1015 may be used to provide information of a user associated with a request indicated in the query indicator 1010. The category indicators 1020a-1020c may be used to indicate information which may be used to select a query and/or a responder. For example, a category, keyword, topic, classification, etc. associated with a request may be indicated in the category indicators 1020a-1020c. For example, the category indicator 1020c may be used to select ‘Opinion’ type queries. The responder indicators 1025a-1025c may be used to indicate information of a responder associated with a response indicated in the GUI 1000. For example, the responder indicator 1025b may indicate that ‘Bill’ has provided the answer ‘Jerry Rice is the best of all time, Randy Moss is a buffoon.’ The conversation indicators 1035a-1035c may indicate whether a responder is accepting responses. For example, the conversation indicator 1035c might indicate the responder ‘Bob’ who is submitting the answer ‘Randy Moss would out-run, out-leap and out-think Jerry Rice any day.’ indicated by the response indicator 1030c is available to establish a two-way communication. The ‘Reply’ action control 1040 may cause a response indicated in the response control 1030c to be submitted.

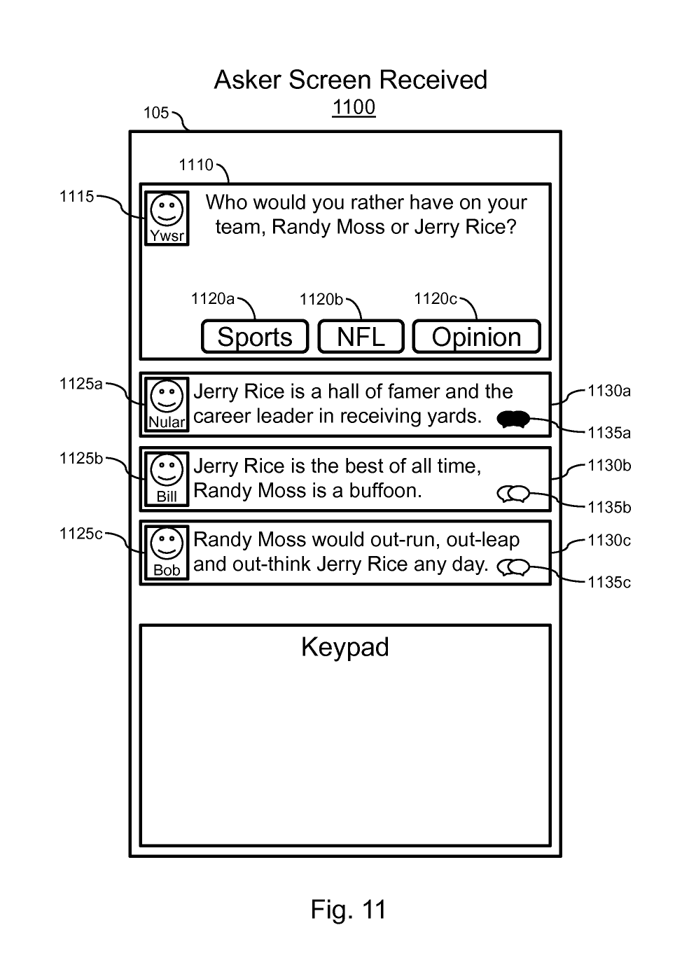

An exemplary GUI 1100 for receiving a response to a question is illustrated in FIG. 11. The GUI 1100 may be presented on a device such as the user system 105 (FIG. 1). The GUI 1100 may include a query indicator 1110, a user indicator 1115, category indicators 1120a-1120c, responder indicators 1125a-1125c, response indicators 1130a-1130c, and responder conversation indicators 1135a-1135c.

The query indicator 1110 may be used to indicate a query to which responses are to be provided. The user indicator 1115 may be used to provide information of a user associated with a request indicated in the query indicator 1110. The category indicators 1120a-1120c may be used to indicate information which may be used to select a query and/or a responder. For example, a category, keyword, topic, classification, etc. associated with a request may be indicated in the category indicators 1120a-1120c. For example, the category indicator 1120c may be used to select ‘Opinion’ type queries. The responder indicators 1125a-1125c may be used to indicate information of a responder associated with a response indicated in the GUI 1100. For example, the responder indicator 1125b may indicate that ‘Bill’ has provided the answer ‘Jerry Rice is the best of all time, Randy Moss is a buffoon.’ The conversation indicators 1135a-1135c may indicate whether a responder is accepting responses. For example, activation of the conversation indicator 1135c might establish a two-way communication with the responder ‘Bob’.

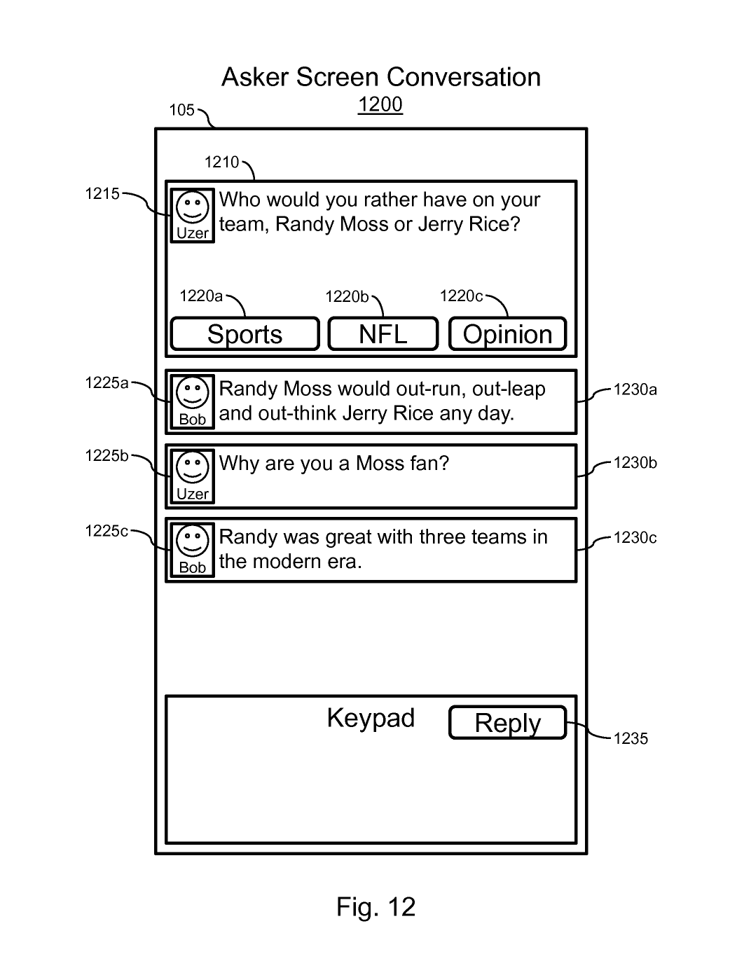

An exemplary GUI 1200 for conducting a two-way interaction or conversation is illustrated in FIG. 12. The GUI 1200 may be presented on a device such as the user system 105 (FIG. 1). The GUI 1200 may include a query indicator 1210, a user indicator 1215, category indicators 1220a-1220c, participant indicators 1225a-1225c, response indicators 1230a-1230c, and action control 1235.

The query indicator 1210 may be used to indicate a query has initiated a conversation. The user indicator 1215 may be used to provide information of a user associated with a conversation. The category indicators 1220a-1220c may be used to indicate information which is associated with a conversation. For example, a category, keyword, topic, classification, etc. associated with a conversation may be indicated in the category indicators 1220a-1220c. For example, the category indicator 1220c may indicate a conversation relates to an ‘Opinion’ type query. The participant indicators 1225a-1225c may be used to indicate information of a participant associated with a response indicated in the GUI 1200. For example, the participant indicator 1125b may indicate that ‘Uzer’ has initiated a conversation with ‘Bob’ by asking ‘Why are you a Moss fan?’ indicated in the response indicator 1230b. The ‘Reply’ action control may cause a response entered by ‘Uzer’ to be added to a conversation as tracked in the GUI 1200.

While the user interfaces described herein have been illustrated using particular types and numbers of interface elements, no limitation is implied thereby, Any number and type of user interface elements as are well known in the art may be used to implement the functionalities described without departing from the scope of the embodiments described herein.

Using the method and systems described herein a user may submit a query or request and engage in an interactive dialogue with a responder. A communication between a user and a responder may be initiated by a requester and/or a responder at any time during a request. A responder may request a conversation prior to responding to a request. A requester may initiate a conversation responsive to an automated and/or stored answer or search result. A responder may initiate a conversation or dialogue or interactive discussion when a requester receives an answer. For example, a responder may request a conversation if a user ‘Likes’ an answer. A conversation may be initiated with a responder associated with an automated response. For example, if a vendor system provides an answer a user may be able to initiate a conversation with a responder associated with a vendor based on a conversation control associated with an answer.

A conversation may occur based on availability of a responder. A responder may be a person other than an answerer who provided a response. For example, a group of responders may elect to respond to conversation requests associated with any member of a group. A responder may elect to be available or not. A responder may block conversations associated with a topic. A rating of a responder and/or a user may be adjusted based on conversations associated with a responder and/or user.

In a system where human responders are used to answer a user request it is important that a human ‘feel’ be preserved. However use of a human responder for every request may be quite cumbersome. If a human responder is required, there may be a time delay associated with locating an appropriate assistant, directing a request to the assistant and receiving a response from the assistant. This may seriously degrade a user experience.

Automation may be applied to use previous answers or other forms of stored information to respond to a user request. However, such a response may appear to be much too rapid to have been produced by a human assistant. As such, users may believe that all answers are being provided automatically.

Even if a human assistant is used to respond to a request, a user may lose patience during a time interval in which a responder is being selected and/or a request is provided to a responder. If a user perceives that a request is being ignored, the user may leave an app or browser window before a response is provided.

For these and other reasons, a method and system of simulating a human responder would be greatly appreciated. A system is provided which allows a user to submit a request for information via a communication device such as a desktop, or portable computer, smart phone, PDA, etc. A request is received by a query server which may distribute the request to a number of users and/or human assistants who may respond to the request. The query server may obtain an automated response to a user request and/or may direct a request to one or more persons who may provide a response to the request.

A database may include information of processing of requests, users, responders, guides or human assistants, resources such as search engines, websites, etc. which may provide an automated answer, and topics, categories and/or keywords which may be used to route a request and/or a response.

If a user submits a request, a response user interface may be provided. If a stored response is found which is an acceptable match to a request the response may be presented in the user interface in a manner intended to mimic a human responder. For example characters might be presented at a rate which is similar to the ability of a person to enter characters at a keypad or keyboard. Presentation of an answer might be modified to include creation and correction of errors such as spelling or grammar. If a request is ambiguous an automated system response requesting clarification of the request might be presented as originating from a human responder selected to respond to the request. An ambiguous response may be disambiguated by a simulation of a conversation. A response which is not a precise match to a user request is found, the response may be presented using an ‘avatar’ or indicator of a responder. A responder may be selected associated with an avatar if a user responds to an answer associated with an avatar.

A system is provided which includes a user system for submitting a query and receiving a response, a search server receiving the query, a database storing information of queries, search results, searchers, responders, users, resources and other information, a responder system receiving a query and providing a response, and a resource system providing answers and/or other media responsive to a request or query or search request or question.

A system is implemented to allow a user to submit a query and receive a response. A response may include any type of media such as text, URL's, audio, video, etc. A response may be produced automatically and/or using the assistance of a person. A query may be submitted using any suitable device and/or communication service such as SMS, MMS, voice, Instant Messaging, VoIP, internet packet communication, email, etc.

Processing of a query may consist of a plurality of layers. When a query is received, a type may be assigned to a request such as objective and/or subjective. If a query is seeking factual or objective information a query may be evaluated to determine whether the query is unambiguous. If a topic of a query is identified, a responder associated with a topic may be notified that a query relating to a topic is available. If a query is determined to be incomplete or ambiguous an indicator of a responder that is not associated with a particular person may be presented. A response which is presented in a character by character manner which is similar to the typing speed of a human responder may be provided. If a stored answer is found which is a suitable match to a request content of the stored answer may be presented in a similar manner. An indicator of a responder associated with a stored answer may be presented with the stored answer.

If a request is determined to be subjective, a response which relates to a request may be obtained based on stored information. For example, a stored answer which includes a named entity found in a request may be obtained. A response may be presented in a character by character manner. While a response based on stored information is being presented, responders associated with a topic of a request may be notified of a request. Any number of matching responses may be presented while a responder is being sought. A stored and/or automated response may be presented as originating from a source which is not associated with a live responder. A live responder may be notified if a response associated with a stored and/or automated answer is selected for an interactive discussion.

A layer of processing may consist of automated processing of a query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use. Automated processing of a query which is determined to be factual may be different from automated processing of a query which is determined to be subjective. For example, a match to a subjective query may be less precise than a match to an objective query. Different resources may be used to determine a response to a subjective query than a factual query. If an automated response is associated with a responder, a conversation with a responder may be offered.

A second layer of processing of a query may include a human assistant who analyzes the query or “expediter”. An expediter uses the human ability to recognize context in order to determine a response to a query. An expediter may be provided with relevant context of a query, and offered various options for responding to the query. In its simplest form, an expediter might be presented with a question and two or more options for responding to the question. An expediter may be provided with a rich toolset which provides a greater depth and breadth of responses which may be interactive. In at least one embodiment, an expediter may be provided with responses from a predetermined set of resources. An expediter may be used to determine whether a query is subjective or objective. If a query is determined to be subjective an expediter may not be presented with the query. A conversation may occur between a requester and an expediter.

A third layer of processing of a query may include a human assistant who responds to the query or “searcher”. A searcher or responder or answerer may receive an interpreted query, information of a source of the query, and be provided with resources for performing a search responsive to a query. A searcher may formulate a response based on an interpreted query, and submit the response for delivery to a user responsive to the query. In at least one embodiment, a searcher may receive information of resources which may be used to provide a response, and/or resources which are excluded from providing a response. Selection of a responder for a subjective query may be different than selection of a responder for an objective query. A more general matching may be applied for selection of a responder for a subjective query. An objective query may be directed to a responder based on a type and level of knowledge required to respond to the query. A conversation may occur between a requester and a searcher.

A resource may be characterized according to various parameters. A resource may be evaluated based on a number of responses obtained from and/or using the resource. A resource may be evaluated based on a number of times that a response obtained from the resource is reused. A resource may be evaluated based on an affiliate relationship between a provider of the resource and a provider of search services. A resource may be ranked or evaluated based on a type of response which is to be obtained from the resource. A resource may be ranked based on a category, a topic, a keyword, a level of information provided, a type of information such as objective and/or subjective, etc. If an answer is provided by a resource, a conversation may be offered between a requester and a responder associated with the resource. A resource may be associated with a number of indicators as a responder based on a topic or category associated with a response or a request.

As used herein, a “request” means a request for information, products, and/or services. A request or search request or query or question may include various types of media, and may be provided by any user system which may establish communication with a server and/or other devices associated with a search service. A request may be referred to as a “search request”, “search query”, or “query”.

A “user” is a person who submits a request and may receive any type of information responsive to a request. A user may be any person or entity. A “guide” is a person who assists in processing a request. A guide may be referred to as a “provider”, “searcher”, “human searcher”, “responder”, “answerer”, “expediter”, “transcriber”, “specialist” or “generalist”. Guides may be assigned various roles. A guide may be a user. A guide who transcribes a user request from one form to another may be referred to as a transcriber. A guide who reviews a query, determines a most likely response, and may modify a query may be referred to as an expediter or “ambassador”. A guide who performs a search for queries associated with a specific category may be referred to as a specialist. A guide who performs a search for queries regardless of category may be referred to as a generalist. Any guide may perform any role.

An “advertiser” is any person and/or entity which may provide promotional information or “advertisements” to be delivered to a user. An advertisement may take various forms and/or may include media of any sort which can be delivered to a user device. A “result”, “response”, “answer”, or “search result” is any information which has been determined to be a response to a request. A result may include an advertisement. A result may be any information which is provided as a response to a request. A “resource” or “search resource” may be any source of information which may provide a search result and/or other information. A resource may include a search engine, a web server, a software application, an API, printed media, an RSS feed, streaming media, a web page, a database, etc. A “profile” may be any information associated with a person such as demographic data, geographic data, personality data, affiliations, etc. A result may be an “organic” result which is produced by a search which has no intentional bias applied. A result may be a “sponsored” result which is provided and/or approved by a provider with a commercial interest in the response and/or providing the response to a user based on a request for information associated with the sponsored answer or sponsored result.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, an application, regular mail and/or any other suitable type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, and/or any other communication device might be used to establish a communication session.

Communication between a user, a guide, a resource and/or a search system may include conversion of text to speech and speech to text. Any type of media which can be sent and/or received using a communication system may be part of a communication session. A communication session may be conducted using any or all communication services associated with a user, a guide, a resource, and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, a responder, an advertiser and/or a request may be rated. Rating information may be obtained from a user, a guide, an advertiser and/or an administrator of a search system. Rating information may be used to select a user, a guide, a request, a result, a responder, an advertiser, and/or any item based on information associated with an item indicated in a database. A search service may be compensated by advertising revenue. Advertising and/or content may be delivered to a user and/or a guide using any communication service associated with a user and/or a guide. An advertiser may request and obtain information regarding usage, users, demographics, affiliations, etc. associated with queries, keywords, categories, resources etc. and may submit sponsored answers and associate sponsored answers with queries based on information provided.

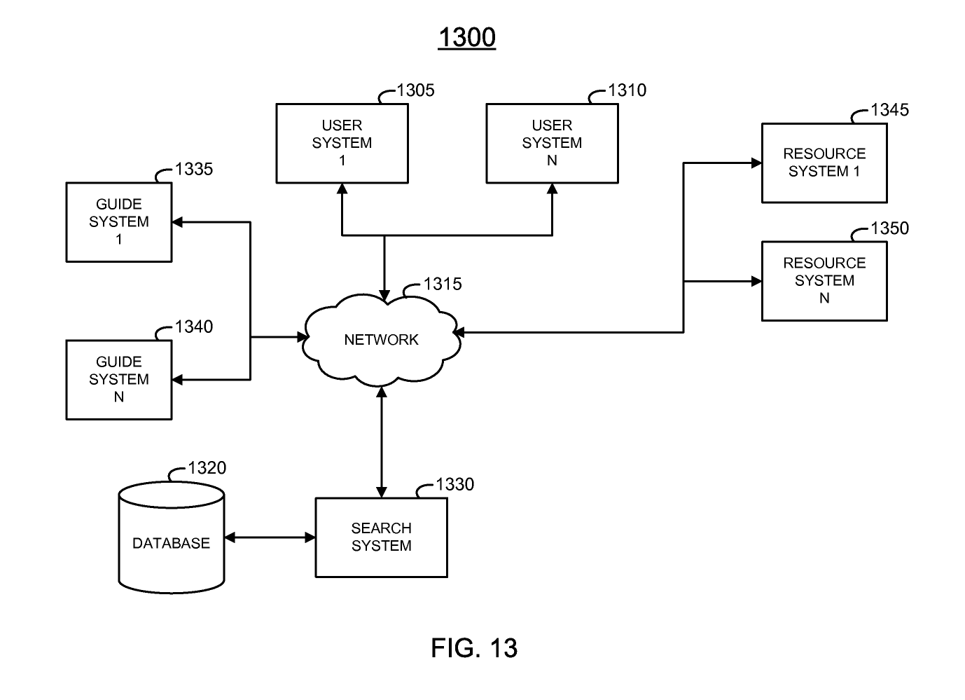

As illustrated in FIG. 13, system 1300 includes user systems 1305, 1310, a network 1315 such as the Internet, a search system 1330, a database 1320, which may comprise various records, guide systems 1335, 1340, and resource systems 1345, 1350.

While only a few systems associated with a user, a resource, and a guide or responder are depicted in FIG. 13 it is within the scope of the disclosure for multiple systems for a user, resource, responder and guide to be utilized. In particular it is envisioned that many user, resource and guide systems may be implemented. The search system 1330 may be a composed of many components as described further herein.

Any user system (e.g. the user system 1305) can be used, to submit a request to the search system 1330 and/or receive a result and/or other information. Any user system may receive and/or provide a response, and/or may provide compensation to the search system 1330.

The network 1315 may be a global public network of networks (i.e., the Internet) and/or may consist in whole or in part of one or more private networks and communicatively couples the user systems 1305, 1310, the guide systems 1335, 1340, and the resource systems 1345, 1350 with the other components of the system such as the search system 1330, and the database 1320. The network 1315 may include one or more wireless networks which may enable wireless communication between the various elements of the system 1300. For example, the search system 1330 may receive messages which may be routed via a wireless network controlled by a wireless service to the user systems 1305, 1310. A wireless service may receive messages from the guide systems 1335, 1340 via a wireless network which is a part of the network 1315, and provide the messages to the search system 1330 via an internet connection which is part of the network 1315. Similarly a voice communication via wired and/or wireless communication might be established between any elements of the system 1300.

The search system 1330 allows interaction to occur among the user systems 1305, 1310, the guide systems 1335, 1340, and the resource systems 1345, 1350. For example, a request can be transmitted from the user system 1305 to the search system 1330, which may provide information obtained from the database 1320, which may include an advertisement to the user system 1305. Similarly, a search result from an answerer operating the guide system 1335 and/or the resource system 1345 might be routed to the search system 1330, which might process the search result, formulate a response and provide a message to the user system 1305. Any type of communication between users, resources and/or guides may be mediated and/or facilitated by the search system 1330, and/or other elements of the system 1300.

The search system 1330 is communicatively coupled with the database 1320. As will be described herein in further detail below, the database 1320 includes data that is processed in association with operation of the embodiments. Although FIG. 13 illustrates the database 1320 as a separate component of the system, the database 1320 may be integrated with the search system 1330. Further, the records maintained in the database 1320 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 1320 may reside in any suitable elements of the system 1300. Any or all elements of the system 1300 may include any or the entirety of the database 1320.

The user systems 1305, 1310, the guide systems 1335, 1340, the resource systems 1345, 1350 and the search system 1330 may include equipment, software, systems and personnel required to send and/or receive messages between a user system 1305, 1310, the guide systems 1335, 1340, the resource systems 1345, 1350 and/or the search system 1330 using the network 1315. The database 1320 includes information which may allow the search system 1330 to establish communication between any or all of the elements of the system 1300.

A user system, a guide system, and/or a search system may be a desktop, portable, or tablet PC or Mac®, a mobile phone, a smart phone, a PDA, a server system, a landline phone, a specialized communication terminal, a terminal connected to a mainframe, or any other communication hardware and/or system. The search system 1330 may include one or more servers, computers, etc. For example, servers such as the PowerEdge® 2900 by Dell, or the BladeCenterJS22 by IBM, or equivalent systems might be used to implement elements of the search system 1330. The search system 1330 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems, resource systems and/or to implement the search system 1330.

A user may be identified by the search system 1330. When a user system, such as the user system 1305, establishes a communication session with the search system 1330, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 1305 and a resource system, a guide system, a sponsor system and/or the search system 1330. Information such as a keyword, a category, a user profile, a request, a result, etc., may be associated with a user. A user may be required to provide profile information to the search system 1330. A user may elect to receive requests from the search system 1330. Parameters and/or attributes may be associated with a resource as will be further described herein below. Information of a user may be stored in the database 1320.

A guide or answerer may be required to register with the search system 1330. As part of a registration process, at least one communication method is associated with a guide. In at least one embodiment, a guide may register with the search system 1330 and establish a username and password which are associated with the guide. A guide may login to the search system 1330 using a web browser functionality of the guide system 1335 in order to communicate with the search system 1330. Multiple communication services may be associated with a guide and may allow a communication session to be established between a guide system such as the guide system 1335 and a user system, a resource system, a sponsor system, and/or the search system 1330. Multiple identifiers of a guide may be associated with each other. Information such as IM credentials, an email address, a phone number, a URL, a username, etc., of a guide may be identified which may allow the search system 1330 to establish a communication session between a guide system and a user system, a resource system, a sponsor system and/or the search system 1330.

When a guide registers with the search system 1330 the guide may be associated with one or more keywords, categories, profiles, and/or other information. Information associated with a guide may be stored in the database 1320 and may be used for various purposes. Information associated with a guide may be used to rank requests, resources, results, advertisements, sponsors and/or other information which may be presented to the guide. In at least one embodiment, payment information is associated with a guide. In at least one embodiment, a guide may be required to undergo testing to determine whether a guide is able to perform any tasks which may be required by the search system 1330. For example, a guide may be assigned to a role such as translator, transcriber, expediter, generalist, specialist, auditor, etc. A guide may be registered by a sponsor. A sponsor may provide compensation to a sponsored guide. A sponsor may designate personnel associated with the sponsor as responders.

Records may be maintained in the database 1320 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein.

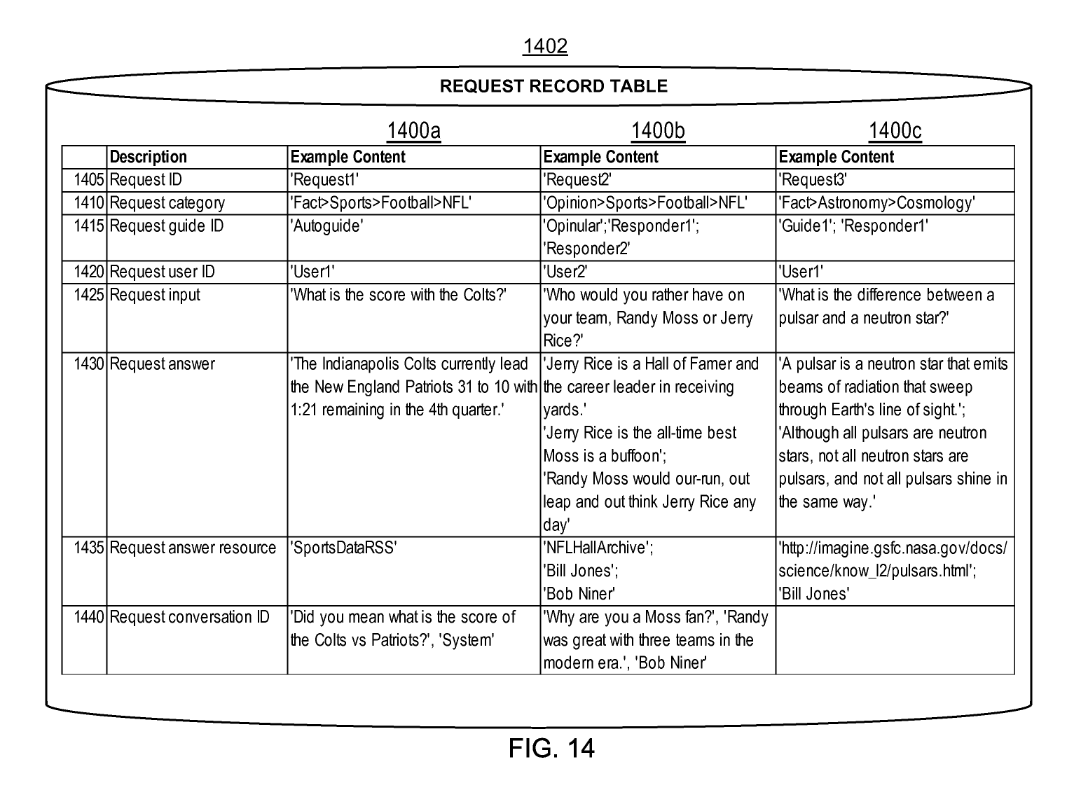

As illustrated in FIG. 14 an exemplary request record table 1402 which may comprise a number of request records is provided. One or more request records may be associated with or resident in the database 1320 (FIG. 13). The request record table 1402 may include information of requests which may be processed. The request records 1400 may include a request ID field 1405, a request category field 1410, a request guide ID field 1415, a request user ID field 1420, a request input field 1425, a request answer ID field 1430, a request answer resource field 1435, and a request conversation ID field 1440.

The request ID field 1405 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 1405. In at least one embodiment, a random number is indicated in the request ID field 1405. Using the example in FIG. 14, ‘Request1’ is the request ID associated with the request record 1400a.

The request category field 1410 may include information of a category associated with a request. Information indicated in the request category field 1410 may be used to select an item associated with a request. For example, a category associated with a request may be used to rank responders who may be associated with the type of request. Likewise, a category associated with a request may be used to rank requests which may be presented to a guide. A category associated with a request may be determined based on factors such as keywords of a query, a profile of a user, a selection of a guide, a user history, an action of a user, an action of a responder, etc. A category associated with a system taxonomy may be indicated in the request category field 1410. A category may be associated with a request automatically and/or using the assistance of a person. Using the example in Fig. example in FIG. 14, ‘Request2’ may be categorized as ‘Opinion>Sports>Football>NFL’ as indicated in the request record 1400b. This may indicate that a person or item associated with the category ‘Opinion>Sports>Football>NFL’ may have a higher ranking for responding to ‘Request2’. A category of a request may be associated with a user submitting the request. Content of a request such as a keyword, named entity, etc. may be used to assign a category or type to a request. A classification as subjective or objective may be required in order that request may be submitted.

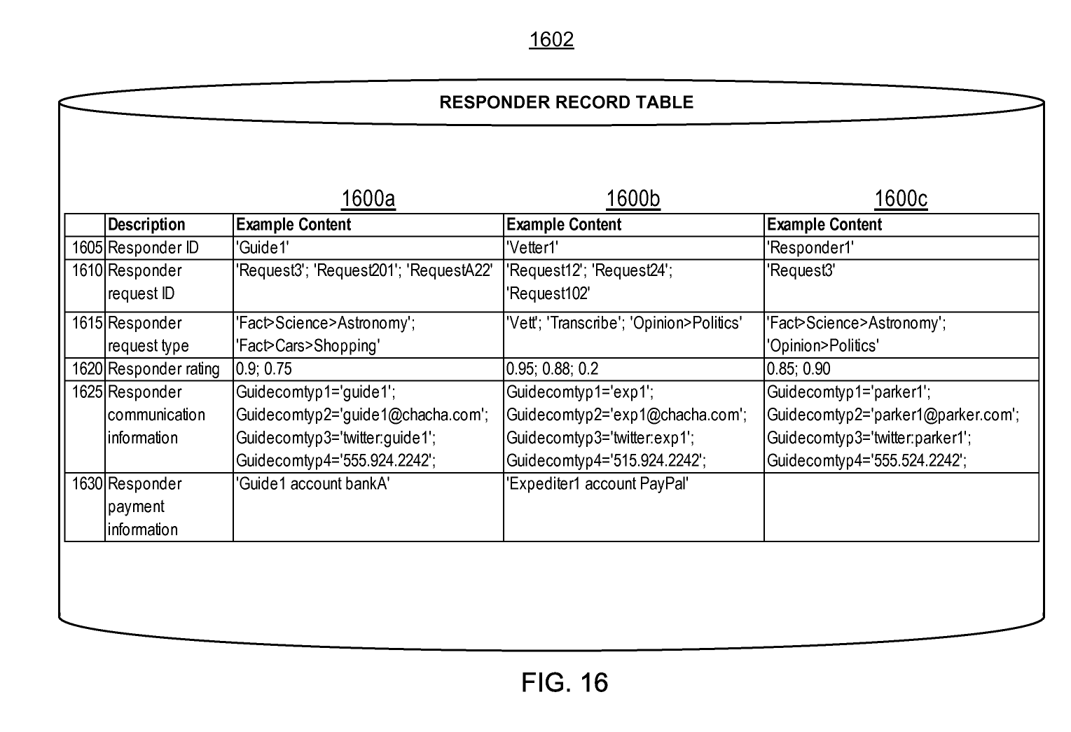

The request guide ID field 1415 may include information of a number of guides associated with a request. Content of the request guide ID field 1415 may be used to obtain information of a guide using a record such as the responder record 1600b (FIG. 16). If a person is selected for a request, elects to receive a request, provides a response to a request, reviews a result of a request and/or completes a request, an identifier of the person may be indicated in the request guide ID field 1415. Using the example in FIG. 14, ‘Opinular’, ‘Responder1’ and ‘Responder2’ are associated with ‘Request2’. This may for example indicate that ‘Request2’ has received an automated response from ‘Opinular’ and a response from ‘Responder1’ and ‘Responder2’.

The request user ID field 1420 may include information of a number of users associated with a request. Content of the request user ID field 1420 may be used to obtain information of a user associated with a request. For example, if a request is submitted by a user, an identifier of the user may be indicated in the request user ID field 1420. A request may not be associated with a user request. For example, the search system 1330 (FIG. 13) may provide requests to persons which are not directly related to a user request. The search system 1330 may provide a request to a responder based on a selection of the request by a user, a responder, an advertiser, etc. Using the example in FIG. 14, ‘User1’ is associated with ‘Request1’ and ‘User2’ is associated with Request2′. This may indicate that ‘Request1’ was submitted by ‘User1’ while ‘Request2’ was submitted by ‘User2’.

The request input field 1425 may include information of a request. Content of the request input field 1425 may be provided to a person who accepts a request. Content of the request input field 1425 may include any type of information. For example, a pointer to audio, video, text, and/or other media may be indicated in the request input field 1425. As illustrated in FIG. 14, the query ‘What is the difference between a pulsar and a neutron star?’ is the request input associated with ‘Request3’, as indicated in the request record 1400c. In at least one embodiment, the request input field 1425 may indicate an original user request, a categorization, and a rewritten user request.

The request answer ID field 1430 may include information of a response associated with a request. Content of the request answer ID field 1430 may be provided to a responsive to a request. Content of the request answer ID field 1430 may be stored in the database 1320 (FIG. 13). Content of the request answer field 1430 may be reviewed and/or rated by a user, a guide, an answerer and/or an administrator. As illustrated in FIG. 14, the responses ‘A pulsar is a neutron star that emits beams of radiation that sweep through Earth's line of sight.’, and ‘Although all pulsars are neutron stars, not all neutron stars are pulsars, and not all pulsars shine in the same way.’ are associated with ‘Request3’ as illustrated in the request record 1400c. While a text response to a query is used for the purposes of illustration, any type of media may be indicated in the request answer ID field 1430. In at least one embodiment, a text response and a URL associated with a source of the text response may be indicated in the request answer ID field 1430. In at least one embodiment, a responder may select a response which may cause a URL associated with the response may be inserted in the request answer resource field 1435.

The request answer resource field 1435 may include information of a resource associated with a request. Content of the request answer resource field 1435 may be used for various purposes. A URL associated with a response may be used to determine whether a response is reliable. As illustrated in FIG. 14, a URL associated with an RSS feed is associated with ‘Request1’ which may indicate that a response associated with ‘Request1’ must be treated according to a pre-determined set of rules. For example, an opinion-type response associated with a particular responder may be more likely to be reused based on a rating of the responder. For example, if a user votes a response of a responder as positive a future response of the responder which is associated with a category of the response may be more likely to be presented. A response to a subjective request may be obtained from a resource such as the resource ‘NFLHallArchive’ indicated in the request answer resource field 1435. If a response is not received from a responder within a predetermined time period of receipt of a request a response extracted from a resource may be provided. Likewise if less than a pre-determined number of responses is returned a response obtained from a resource may be provided. For example, a snippet including a named entity indicated in a user request may be extracted from a resource, which snippet may be provided responsive to a request. Using the example in FIG. 14, the sentence ‘Jerry Rice is a Hall of Famer and the career leader in receiving yards.’ Might be extracted from ‘NFLHallArchive’ based on the presence of the named entity ‘Jerry Rice’. As the query is subjective, the response may be accepted or relevant despite not being a direct answer to the user query.

The request conversation ID field 1440 may include information of a conversation associated with a request. A conversation may be initiated automatically. As illustrated in the Request record 1400a, if a query is an incomplete match to a stored query, a system response may appear as a conversation request from an alias. As indicated in the request record 1400b, the request conversation ID field 1440 may include a response of a responder and an identifier of a responder. Any number of conversations associated with a request may be indicated in the request conversation ID field 1440.

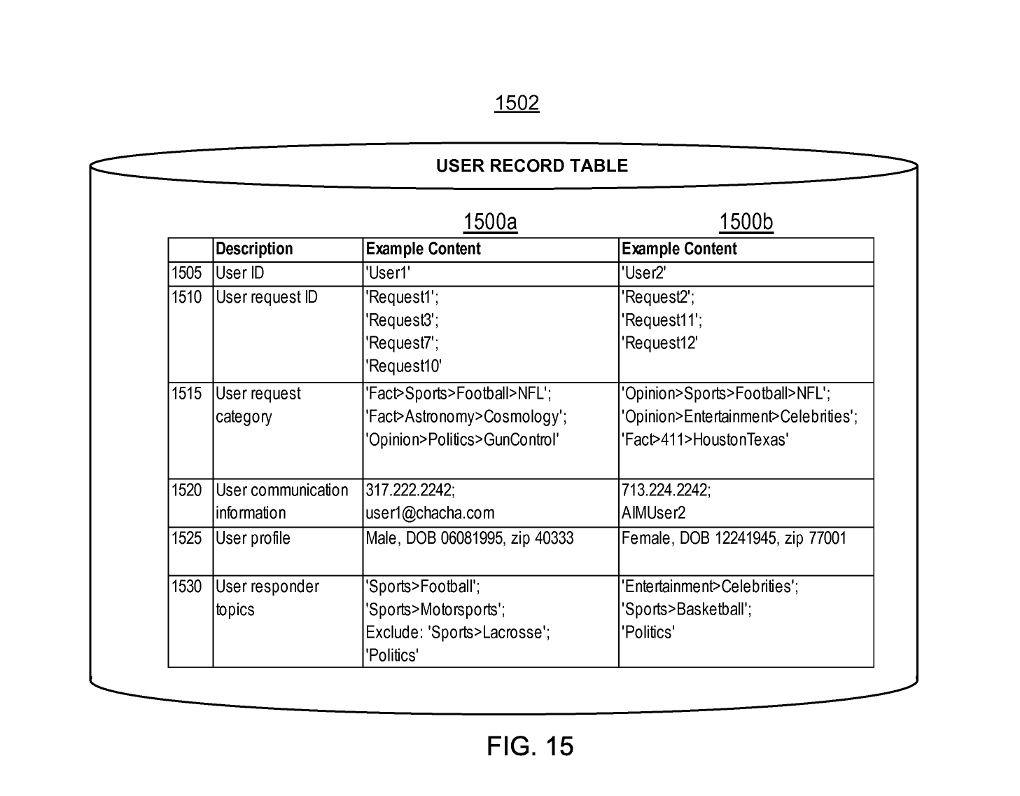

As illustrated in FIG. 15 an exemplary user record table 1502, which may comprise a number of user records is provided. One or more user records may be associated with or resident in the database 1320 (FIG. 13). The user record table 1502 may include information of users. The user records 1500 may include a user ID field 1505, a user request ID field 1510, a user request category field 1515, a user communication information field 1520, a user profile field 1525, and a user responder topics field 1530.

The user ID field 1505 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 1505. Using the example in FIG. 15, ‘User1’ is the user ID associated with the user record 1500a.

The user request ID field 1510 may include information of a number of requests associated with a user. A user request ID may be for example a pointer to a request record associated with a request submitted by a user. If a user submits a request, a request ID may be added to the user request ID field 1510. Using the example illustrated in FIG. 15, ‘Request2’, ‘Request11’ and ‘Request12’ are associated with ‘User2’ as indicated in the user record 1500b. This may indicate that ‘User2’ has submitted ‘Request2’, ‘Request11’ and ‘Request12’.

The user request category field 1515 may include information regarding a category or type associated with a user request. For example, if a request is directed to a type of processing or a category, etc. a type and/or category associated with the processing may be indicated in the user request category field 1515. In at least one embodiment, the user request ID field 1510 and the user request category field 1515 are linked by for example a pointer. In at least one embodiment, a user may be restricted to submitting questions which are subjective or objective type questions. A user may be restricted to accepting requests which are subjective or objective. Content of the user request category field 1515 may be used to determine categories of queries which may be directed to a guide, a user and/or a resource. Content of the user request category field 1515 may be used to rank resources, guides, advertisements, resources, etc. and may affect a probability that an item will be presented to a user, guide or responder.

The user communication information field 1520 may include information of a number of communication services associated with a user. Any information which may be used to establish communication with a user may be indicated in the user communication information field 1520. For example, a telephone number, an email address, an IM credential, a URL, a username, a password, and/or other communication information may be indicated in the user communication information field 1520. Using the example in FIG. 15, the phone number ‘317.222.2242’ and the email ‘user1@chacha.com’ are associated with ‘User1’.

The user profile field 1525 may include information of a profile associated with a user. For example, demographic, geographic, affiliation, personality, and/or other types of anthropic and/or other characteristic information may be associated with a user. A user may provide profile information as part of a registration process. User profile information may be obtained from a database provided by a third party. User profile information may be determined based on test, polling, query history, peer review, and/or other information associated with a user. Using the example illustrated in FIG. 15, ‘Female, DOB 12241945, zip 77001’ are associated with ‘User2’. Profile information may be used to match information provided by a user to other information. For example, a ranking of a guide for a query of a user may be adjusted based on a profile associated with the user. An answer might be modified based on geographic, demographic, etc. profile information of a user. A responder, guide and/or resource might have a different rating and/or ranking based on profile information of a user.

The user responder topics field 1530 may include information of topics associated with a user for which the user may be selected as a responder. The user responder topics field 1530 may include topics for which a user has elected to receive questions and/or topics for which a user has requested not to receive questions. Content of the user responder topics field 1530 may be used to rate a user for a request. As illustrated in FIG. 15, a query associated with ‘Politics’ or ‘Sports’ might be directed to ‘User1’ and ‘User2’, but if the query is associated with ‘Sports>Lacrosse’ ‘User1’ would not receive the query. A user may elect to receive subjective and/or objective requests associated with a category.

As illustrated in FIG. 16 an exemplary responder record table 1602 which may comprise a number of responder records is provided. One or more responder records may be associated with or resident in the database 1320 (FIG. 13). The responder record table 1602 (FIG. 16) may include information of responders. The responder records 1600 may include a responder ID field 1605, a responder request ID field 1610, a responder request type field 1615, a responder rating field 1620, a responder communication information field 1625, and a responder payment information field 1630.

The responder ID field 1605 includes an identifier of a responder which is preferably unique and is preferably used consistently. A responder ID serves to distinguish a responder record associated with a responder from a responder record associated with other responders. Any number of characters, numbers, and/or other indicators may be used to indicate a responder ID. In at least one embodiment, a random number is indicated in the responder ID field 1605. In at least one embodiment, a pseudonym selected by a responder may be indicated in the responder ID field 1605. A first and last name of a responder may be indicated in the responder ID field 1605. Using the example in FIG. 16, ‘Guide1’ is the responder ID associated with the responder record 1600a.

The responder request ID field 1610 may include information of a number of requests associated with a responder. Content of the responder request ID field 1610 may be used to obtain information of a request. For example, if a user request has been determined to require a number of requests to be performed, the search system 1330 (FIG. 13) may assign a unique ID to the requests and may distribute information of the requests to responders. Using the example in FIG. 16, ‘Vetter1’ is associated with ‘Request12’, ‘Request24’ and ‘Request102’ as indicated in the responder record 1600b. This may indicate that ‘Vetter1’ has responded to those requests by for example classifying, transcribing, clarifying, etc.

The responder request type field 1615 may include information of a number of types of requests which may be processed by a responder. For example, a category and/or keyword associated with a request, a type of request, temporal information associated with a request, etc., which may be used to determine if a responder is to be presented with a request may be indicated in the responder request type field 1615. In at least one embodiment, a responder may be assigned to a particular type of request as part of a registration process. A responder may select a type of request which the responder may perform. A responder may be required to pass a test in order to be associated with a type of request. For example if a responder is to provide responses to factual queries, an assessment of a responder's knowledge of a topic may be performed. A responder may be assigned to a role such as vetter, expediter, searcher, etc., which may be indicated in the responder request type field 1615. A request indicating a keyword may be directed to a responder. Using the example in FIG. 16, ‘Responder1’ is associated with ‘Fact>Science>Astronomy’ and ‘Opinion>Politics’ as indicated in the responder record 1600c. This may for example indicate that ‘Responder1’ may be presented with and/or selected to respond to requests indicating those classifications.

The responder rating field 1620 may include information of a number of ratings associated with a responder. For example, quality, speed, peer review, etc., may be used to determine a rating of a responder. A rating of a responder may be used for purposes such as determining compensation for the responder (e.g. bonus points), selecting a responder to respond to a request, matching a request to a responder, etc. In at least one embodiment, the responder request type field 1615 and the responder rating field 1620 may be linked by, for example, a pointer. Using the example in FIG. 16, ‘Guide1’ and ‘Responder1’ are associated with the type ‘Fact>Science>Astronomy’ and ‘Vetter1’ and ‘Responder1’ are associated with the type ‘Opinion>Politics’. A response associated with ‘Guide1’ may be more likely to be provided responsive to a request associated with ‘Fact>Science>Astronomy’, while ‘Responder1’ might be more likely to be provided with an opportunity to respond to a request associated with ‘Opinion>Politics’ based on the ratings indicated in the responder rating field 1620.

The responder communication information field 1625 may include information of a number of communication services associated with a responder. For example, a user name and password, an email address, an IM credential, a phone number, a web page, a physical address, etc., may be indicated in the responder communication information field 1625. Using the example illustrated in FIG. 16, ‘Guide1’ is associated with the login ID ‘guide1’, the email ‘guide1@chacha.com’, the Twitter account ‘twitter.guide1’, and the phone number ‘555.924.2242’. This may indicated that ‘Guide1’ may be contacted using the associated communication services.

The responder payment information field 1630 may include information of a payment method associated with a responder. For example, banking information, a PayPal® account, a Western Union® account, etc., may be indicated in the responder payment information field 1630. Content of the responder payment information field 1630 may be used to provide compensation to a responder. For example, payment may be made by Automated Clearing House (ACH), wire transfer, etc., using information indicated in the responder payment information field 1630. If a responder is not compensated, the responder payment information field 1630 may be blank.

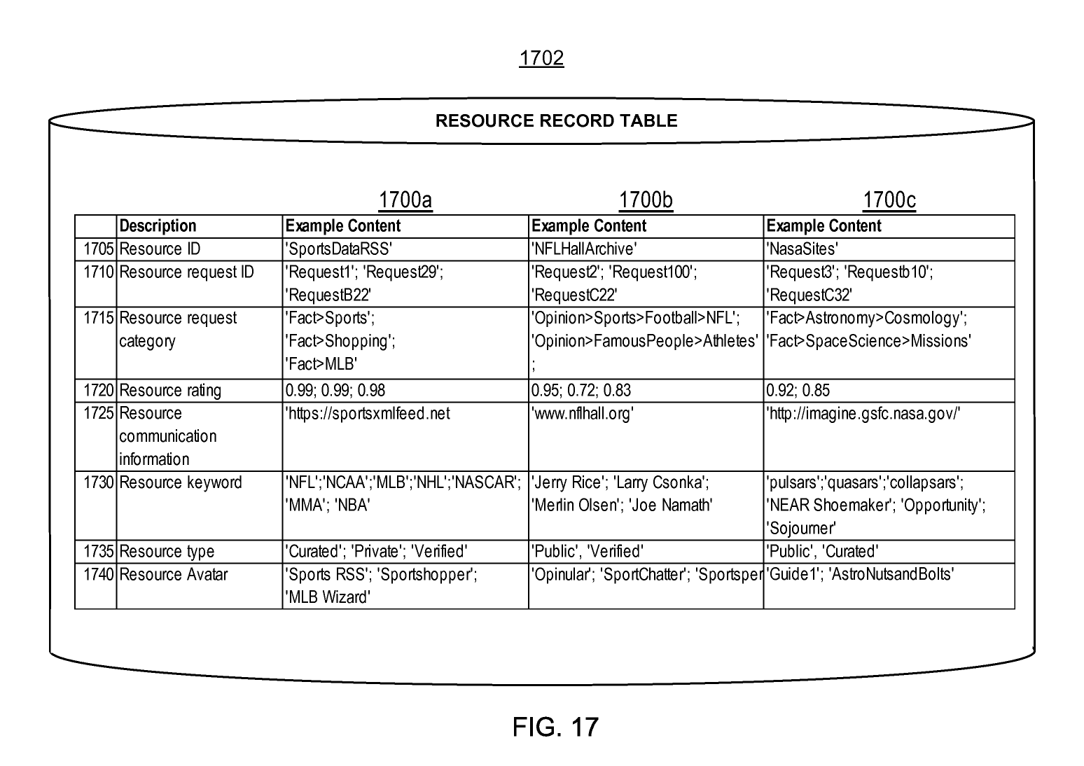

As illustrated in FIG. 17 an exemplary resource record table 1702 which may comprise a number of resource records is provided. One or more resource records may be associated with or resident in the database 1320 (FIG. 13). The resource record table 1702 (FIG. 17) may include information of resources. The resource records 1700 may include a resource ID field 1705, a resource request ID field 1710, a resource request category field 1715, a resource rating field 1720, a resource communication information field 1725, a resource keyword field 1730, a resource type field 1735 and a resource avatar field 1740.

The resource ID field 1705 includes an identifier of a resource which is preferably unique and is preferably used consistently. A resource ID serves to distinguish a resource record associated with a resource from a resource record associated with other resources. Any number of characters, numbers, and/or other indicators may be used to indicate a resource ID. Using the example in FIG. 17, ‘SportsDataRSS’ is the resource ID associated with the resource record 1700a. This may indicate that ‘SportsDataRSS’ has been used to produce a search result, and is accessible to a guide, but may not be accessible to a user.

The resource request ID field 1710 may include information of a number of requests associated with a resource. Content of the resource request ID field 1710 may be used to obtain information of a request. For example, if a resource has been used to respond to a request, an identifier of the request may be indicated in the resource request ID field 1710. Using the example in FIG. 17, ‘Request2’, ‘Request100’ and ‘RequestC22’ are associated with the resource ‘NFLHallArchive’ as indicated in the resource record 1700b. This may indicate that ‘NFLHallArchive’ has been utilized to respond to ‘Request2’, ‘Request100’ and ‘RequestC22’.

The resource request category field 1715 may include information of a number of categories of requests which may be processed by a resource. For example, a category and/or keyword associated with a request, a type of request, profile, etc., which may be used to determine if a resource and/or a result obtained from a resource is to be presented to a responder for a request may be indicated in the resource request category field 1715. In at least one embodiment, a resource may be assigned to a category of request as part of a registration process. A resource may be associated with a user, a group of users, an access right, an advertiser or sponsor, etc. A provider of a resource may select a type and/or category of request for which the resource may be used and/or required. A resource may be associated with a category based on a selection by an administrator, based on success rates of obtaining or providing answers, etc. Using the example in FIG. 17, NASASites' is associated with the category ‘Fact>Astronomy>Cosmology’ and ‘Fact>SpaceScience>Missions’ as indicated by the resource record 1700c.

The resource rating field 1720 may include information of a number of ratings associated with a resource. For example, a rating of a resource may be based on ratings of answers produced using the resource, a contractual agreement, an affiliation, temporal information such as time spent by guides, etc. A rating of a resource may be used to select a resource which is provided to a searcher or guide, to rank a response associated with a resource, etc. In at least one embodiment, the resource request category field 1715 and the resource rating field 1720 may be linked by, for example, a pointer. Using the example in FIG. 17, ‘SportsDataRSS’ has a rating of ‘0.99’ associated with ‘Fact>Sports’, and ‘NFLHallArchive’ has a rating ‘0.83’, associated with “Fact>Sports’ which may for example indicate that ‘SportsDataRSS’ is more likely to produce an acceptable response for that category. A resource may have a rating corresponding to various categories, types of information, types of tasks, keywords, etc.

The resource communication information field 1725 may include information of a number of communication services associated with a resource. For example, a user name and password, an email address, an IM credential, a phone number, a web page, a physical address, etc., may be indicated in the resource communication information field 1725. A communication service indicated in the resource communication information field 1725 may for example be used to indicate a service by which a resource may be accessed. Using the example illustrated in FIG. 17, the URL <<‘https://sportsxmlfeed.net>> is associated with ‘SportsDataRSS’. This may indicate that a query associated with ‘Fact>Sports’ may be submitted to that URL by for example an API.

The resource keyword field 1730 may include information of a number of keywords associated with a resource. A match to a keyword indicated in the resource keyword field 1730 may affect a probability that a request will receive a response associated with a resource. For example, a match may prohibit a query from receiving a result from a resource, may increase a ranking of a resource, may be used to associate a category with a request, may identify a resource to be provided to a guide, responder, vetter, etc. In at least one embodiment, keywords included in requests for which a resource has provided an answer may be more highly ranked for a category associated with the query and the resource.

The resource type field 1735 may include information of a number of types or characteristics associated with a resource. A type may include an indication of an access right, a commercial arrangement, a preference, quality of content, source of content, etc. A searcher may elect to associate a resource with a type. A system administrator may associate a type with a resource. A provider of a resource may designate a type associated with the resource as part of a registration process. Using the example in FIG. 17, ‘SportsDataRSS’ is a ‘Verified’, ‘Private’, ‘Curated’ resource. This may indicate that content of the resource is controlled, that the resource is not accessible to the general public, and that the content of the resource is verified to be correct.

The resource avatar field 1740 may include information of an indicator associated with a resource. An avatar may be presented when a response associated with a resource and a topic is provided. For example ‘Opinular’ might be associated with a response from ‘NFLHallArchive’ if a result associated with the topic ‘Opinion>Sports>Football>NFL’ is provided automatically as indicated by the resource record 1700b.

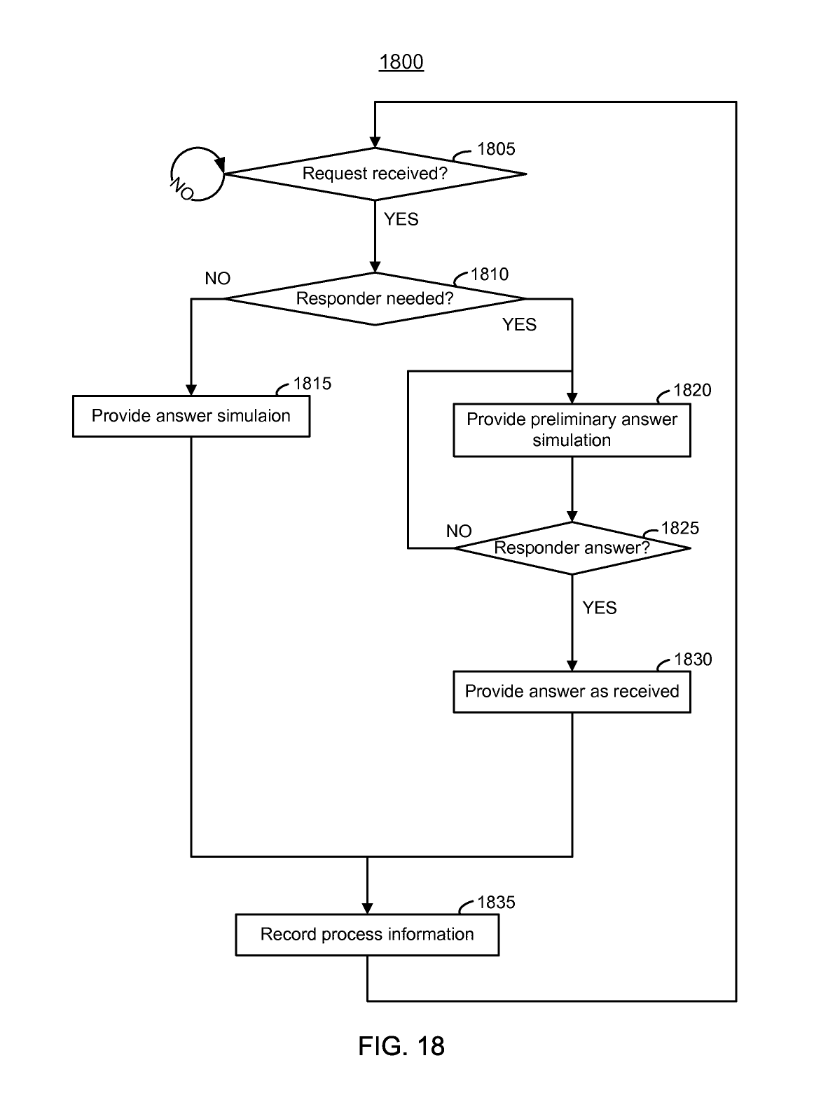

As illustrated in FIG. 18, a process 1800 for providing an answer is provided. The process 1800 may be performed in whole or in part by any suitable element of the system 1300 (FIG. 13). In at least one embodiment, the process 1800 is operative on a server associated with the search system 1330. A request may be a request for an automated answer, a human assisted answer and/or a combination thereof.

In operation 1805 (FIG. 18) a determination is made as to whether a request is received. If it is determined in operation 1805 that a request is not received, control remains at operation 1805 and process 1800 continues. If it is determined in operation 1805 that a request is received, control is passed to operation 1810 and process 1800 continues.

The determination in operation 1805 may be made using various criteria. In at least one embodiment, if a message is received at a system associated with the search system 1330 (FIG. 1), it may be determined that a request is received. For example, if an email message, an SMS, EMS, and/or MMS message, an IM, an IP message, and/or a voice message is received at an address associated with the search system 1330, it may be determined that a request is received. If a message is received at a server associated with the search system 1330, it may be determined that a request is received.

In operation 1810 a determination is made as to whether a responder is needed. If it is determined in operation 1810 that a responder is not needed, control is passed to operation 1815 and process 1800 continues. If it is determined in operation 1810 that a responder is needed, control is passed to operation 1820 and process 1800 continues.

The determination in operation 1810 may be made based on various criteria. If an automated response is found, it may be determined that a responder is not needed. If a user request is subjective, it may be determined that a responder is not needed. If a request is ambiguous, it may be determined that a responder is needed. Any suitable criteria may be used to determine whether a responder is needed.

In operation 1815, an answer simulation is provided. Any number of answers may be provided. If an answer is provided based on stored information an indication may be provided to a requester that a conversation is available based on a status of a person associated with the answer. An answer simulation may include errors and/or other features which might occur during normal text entry by a person. Control is passed to operation 1835 and process 1800 continues.

In operation 1820, a preliminary answer simulation is provided. A preliminary answer may include an automated request for clarification, a statement extracted from a resource which is related to a request, a related answer which is an approximate match to a user request, etc. A simulation may include presentation of a response which includes presentation and deletion of text, pauses, spelling and/or grammar corrections, etc. Responders associated with a topic of a request may be notified of a request while a preliminary answer simulation is provided. Control is passed to operation 1825 and process 1800 continues.

In operation 1825 a determination is made as to whether a responder answers. If it is determined in operation 1825 that a responder answers, control is passed to operation 1830 and process 1800 continues. If it is determined in operation 1830 that responder does not answer, control is passed to operation 1820 and process 1800 continues.

The determination in operation 1830 may be made based on various criteria. If a responder accepts a notification, enters text, or otherwise provides a response, it may be determined that a responder answers. If a time interval passes and a responder does not take an action, it may be determined that a responder has answered. If a user accepts a response included in a preliminary answer simulation, it may be determined that a responder answers. Any suitable criteria may be used to determine whether a responder answers.

In operation 1830, an answer is provided as it is received. An answer of a responder may be provided as text is received from a responder device. Any number of responder answers may be provided in series or parallel. Control is passed to operation 1835 and process 1800 continues.

In operation 1835, process information is recorded. Information of a request, an answer, a category, a keyword, a resource, a user, a guide, a responder, a rating, a ranking, etc. may be recorded. A conversation may be rated, ranked, or deleted. In at least one embodiment, process information is recorded in the database 1320 (FIG. 13). Control is passed to operation 1805 and process 1800 continues.

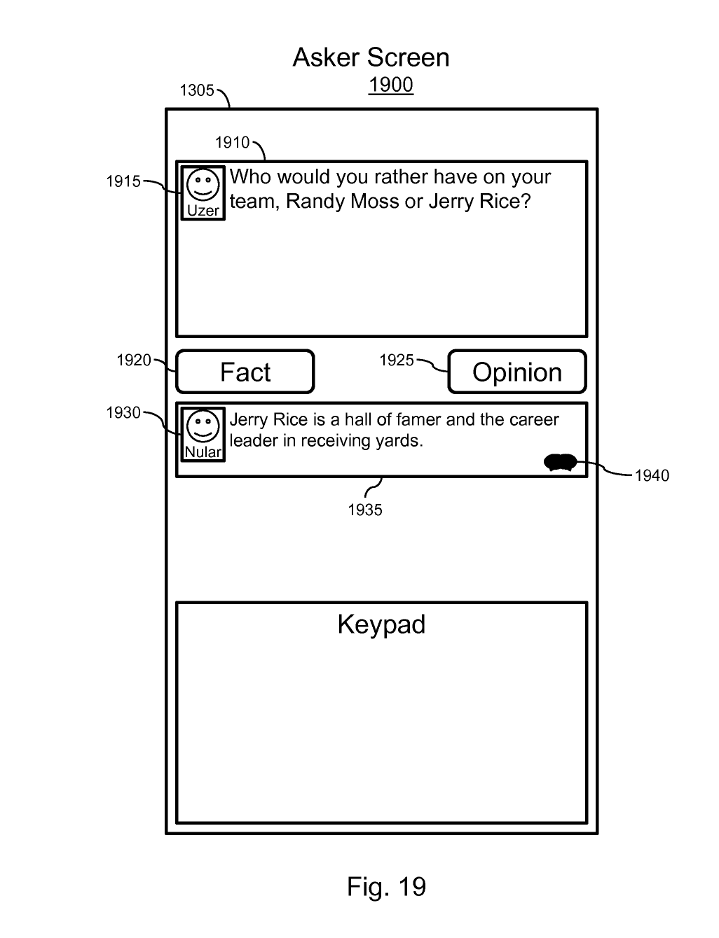

As illustrated in FIG. 19 an exemplary response GUI 1900 is provided. The response GUI 1900 may be provided to a user. The GUI 1900 may be presented using a system such as the user system 1305 (FIG. 13). The GUI 1900 may be used to provide a response any type of request. The GUI 1900 may include a query indicator area 1910, a user identifier 1915, a factual query indicator 1920, an opinion query indicator 1925, a responder indicator 1930, a response indicator 1935, and a conversation indicator 1940.

As illustrated in FIG. 19, the query indicator area 1910 may include a subjective query which has been submitted. The user identifier 1915 may indicate a query submitted using the opinion query indicator 1925. The fact indicator 1920 may be active by default, may be active based on content of a query, may be always active, etc. The responder indicator 1930 may indicate a source of a response. As illustrated in FIG. 19, ‘Nular’ which may be an automated system has responded with an answer indicated in the response indicator 1935 as described herein with respect to FIG. 17. The conversation indicator 1940 may be used to establish a two-way exchange with a responder indicated by the responder indicator 1930. If a responder has declined to receive two-way communications, is an automated system, or for any reason the conversation indicator 1940 may be inactive as indicated by for example the filled indicator in FIG. 19. Any suitable indicator such as color, shading, etc. may be used to indicate that the conversation indicator 1940 is active or inactive. Content of the response indicator 1935 may be presented in a character by character format.

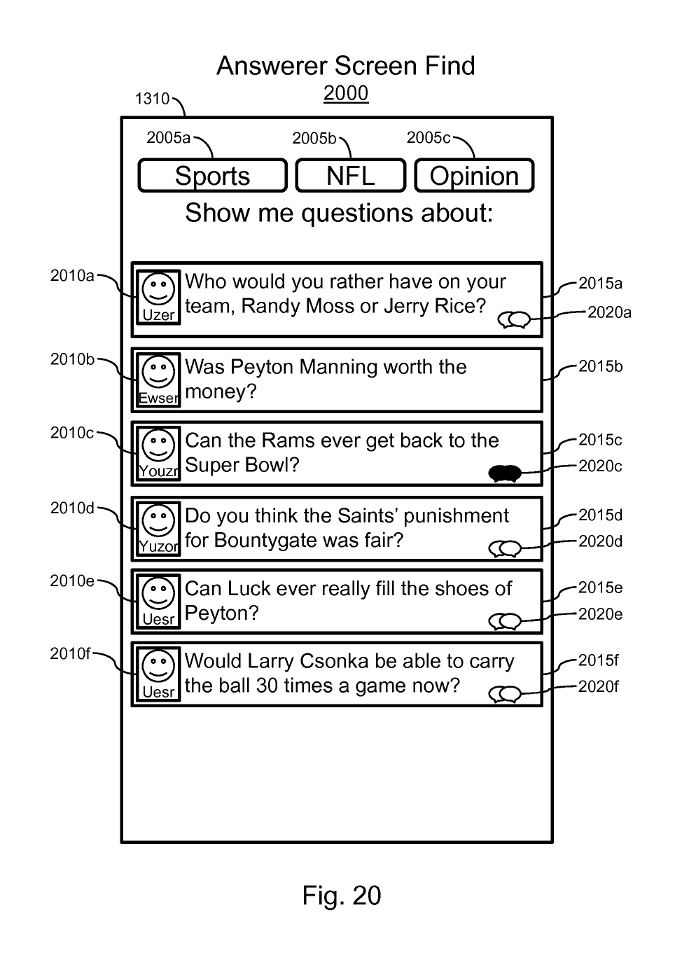

As illustrated in FIG. 20 an exemplary query selection GUI 2000 is provided. The GUI 2000 may be provided to a user, a responder, a guide, etc. The GUI 2000 may be presented using a system such as the user system 1310 (FIG. 13). For example, the GUI 2000 may be presented to a responder while the GUI 1900 is being presented to a requester. The GUI 2000 may be used to obtain information of a query. The GUI 2000 may include selection indicators 2005a-2005c, query indicators 2015a-2015f, user indicators 2010a-2010f, and conversation indicators 2020a, 2020c-2020f.

As illustrated in FIG. 20, the category indicators 2005 may include a category, type, etc. which may be used to select a query. The category indicator 2005a,b may indicate that questions regarding ‘Sports’ and ‘NFL’ are desired. The category indicator 2005c may indicate that queries classified as ‘Opinion’ are to be provided. The user indicators 2010a-2010f may indicate information of a user associated with a request. For example, the user indicator 2010b shows that ‘Ewser’ has submitted the query ‘Was Peyton Manning worth the money?’ as indicated in the query indicator 2015b. The absence of a conversation indicator in the query indicator 2015b may indicate that a user submitting the request does not accept conversations. As illustrated in FIG. 20, the conversation indicators 2020a, 2020c-2020f may indicate that a user associated with a request is available for a two-way communication. For example, the conversation indicator 2020a may indicate that ‘Uzer’ is available for a real-time exchange of information as indicated by the speech bubbles in the conversation indicator 2020a. Any suitable indicator such as color, shading, etc. may be used to indicate status of the conversation indicators 2020a, 2020c-2020f. A responder may be notified of requests associated with topics for which a responder has registered using a GUI such as the GUI 2000.

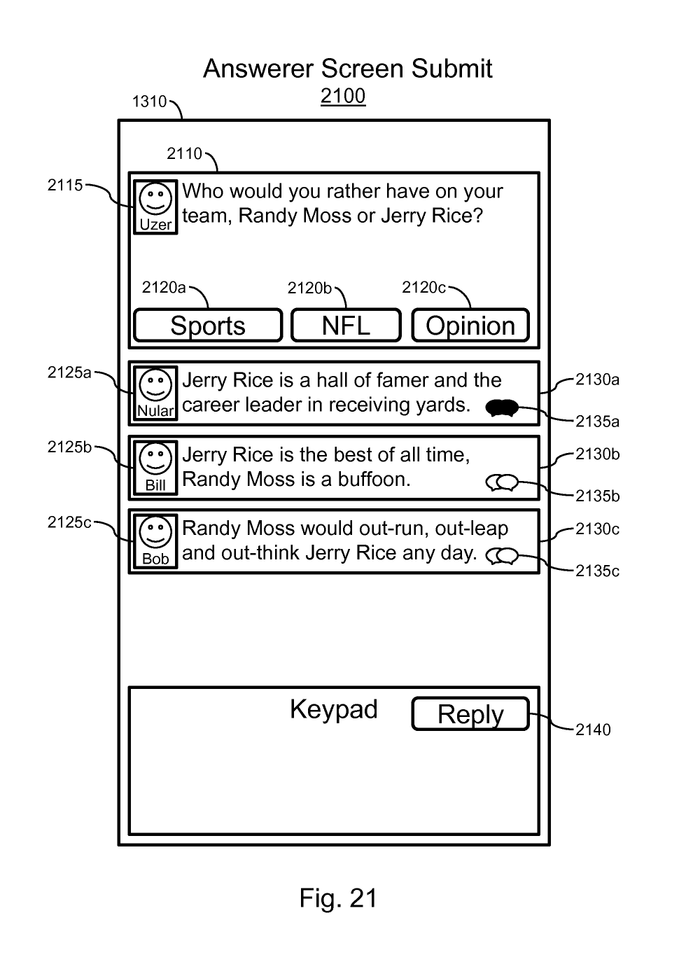

An exemplary GUI 2100 for responding to a question is illustrated in FIG. 21. The GUI 2100 may be presented on a device such as the user system 1305 (FIG. 13). For example, the GUI 2100 may be presented to a responder while the GUI 1900 is being presented to a requester. The GUI 2100 may include a query indicator 2110, a user indicator 2115, category indicators 2120a-2120c, responder indicators 2125a-2125c, response indicators 2130a-2130c, responder conversation indicators 2135a-2135c and action control 2140.

The query indicator 2110 may be used to indicate a query to which responses are to be provided. The user indicator 2115 may be used to provide information of a user associated with a request indicated in the query indicator 2110. The category indicators 2120a-2120c may be used to indicate information which may be used to select a query and/or a responder. For example, a category, keyword, topic, classification, etc. associated with a request may be indicated in the category indicators 2120a-2120c. For example, the category indicator 2120c may be used to select ‘Opinion’ type queries. The responder indicators 2125a-2125c may be used to indicate information of a responder associated with a response indicated in the GUI 2100. For example, the responder indicator 2125b may indicate that ‘Bill’ has provided the answer ‘Jerry Rice is the best of all time, Randy Moss is a buffoon.’ The conversation indicators 2135a-2135c may indicate whether a responder is accepting responses. For example, the conversation indicator 2135c might indicate the responder ‘Bob’ who is submitting the answer ‘Randy Moss would out-run, out-leap and out-think Jerry Rice any day.’ indicated by the response indicator 2130c is available to establish a two-way communication. The ‘Reply’ action control 2140 may cause a response indicated in the response control 2130c to be submitted.

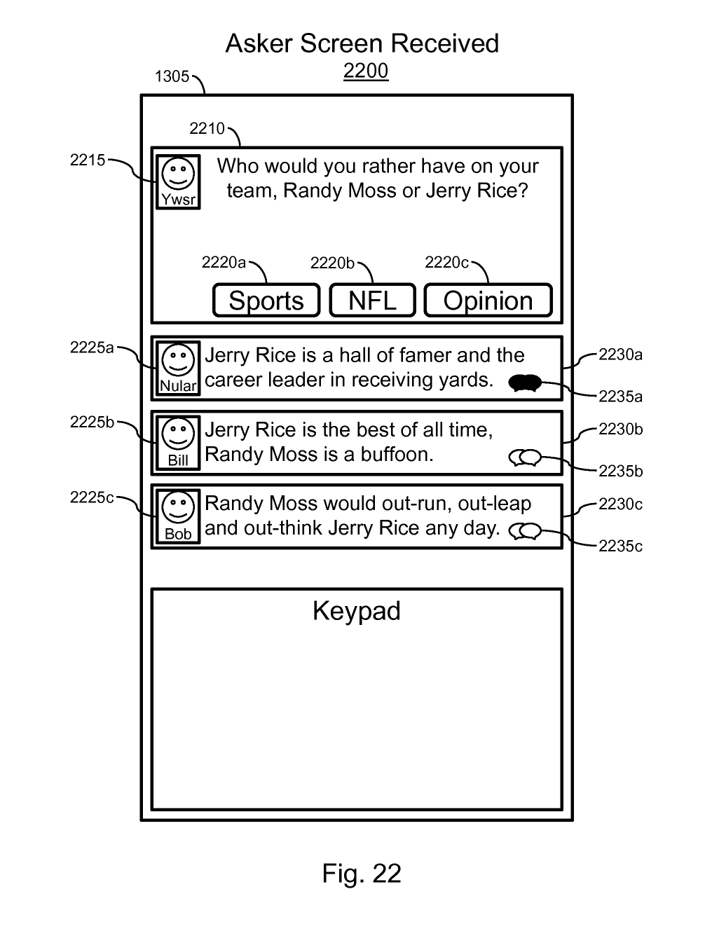

An exemplary GUI 2200 for receiving a response to a question is illustrated in FIG. 22. The GUI 2200 may be presented on a device such as the user system 1305 (FIG. 13). For example, the GUI 2200 may be presented to a requester subsequent to the GUI 1900 (FIG. 19). The GUI 2200 may include a query indicator 2210, a user indicator 2215, category indicators 2220a-2220c, responder indicators 2225a-2225c, response indicators 2230a-2230c, and responder conversation indicators 2235a-2235c.

The query indicator 2210 may be used to indicate a query to which responses are to be provided. The user indicator 2215 may be used to provide information of a user associated with a request indicated in the query indicator 2210. The category indicators 2220a-2220c may be used to indicate information which may be used to select a query and/or a responder. For example, a category, keyword, topic, classification, etc. associated with a request may be indicated in the category indicators 2220a-2220c. For example, the category indicator 2220c may be used to select ‘Opinion’ type queries. The responder indicators 2225a-2225c may be used to indicate information of a responder associated with a response indicated in the GUI 2200. For example, the responder indicator 2225b may indicate that ‘Bill’ has provided the answer ‘Jerry Rice is the best of all time, Randy Moss is a buffoon.’ The conversation indicators 2235a-2235c may indicate whether a responder is accepting responses. For example, activation of the conversation indicator 2235c might establish a two-way communication with the responder ‘Bob’.

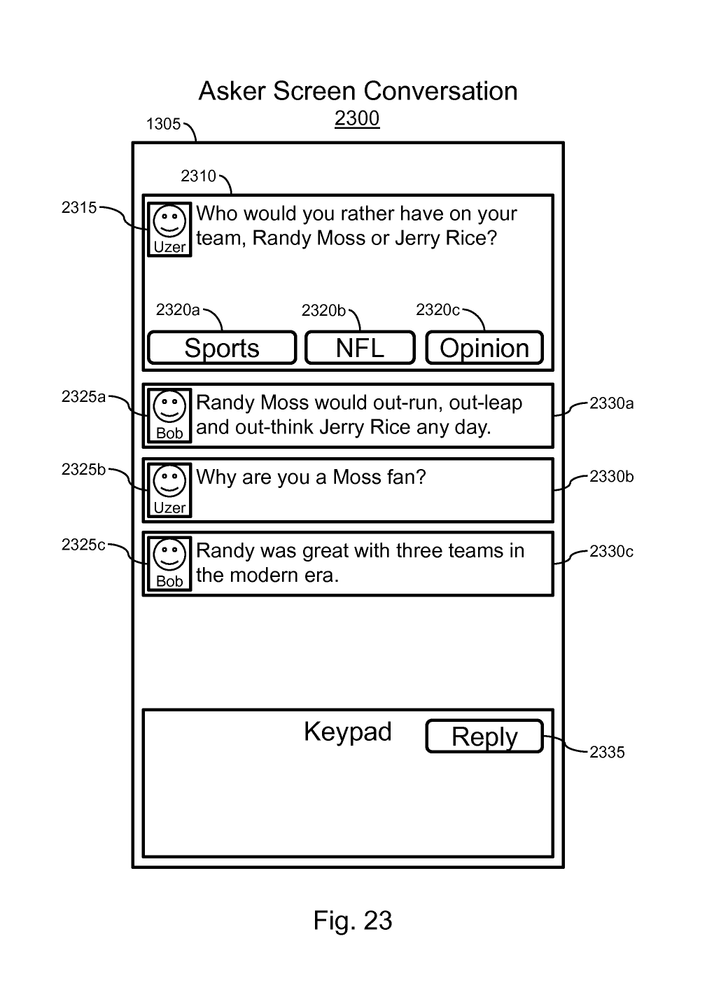

An exemplary GUI 2300 for conducting a two-way interaction or conversation is illustrated in FIG. 23. The GUI 2300 may be presented on a device such as the user system 1305 (FIG. 13). The GUI 2300 may include a query indicator 2310, a user indicator 2315, category indicators 2320a-2320c, participant indicators 2325a-2325c, response indicators 2330a-2330c, and action control 2335a, 2335b.

The query indicator 2310 may be used to indicate a query has initiated a conversation. The user indicator 2315 may be used to provide information of a user associated with a conversation. The category indicators 2320a-2320c may be used to indicate information which is associated with a conversation. For example, a category, keyword, topic, classification, etc. associated with a conversation may be indicated in the category indicators 2320a-2320c. For example, the category indicator 2320c may indicate a conversation relates to an ‘Opinion’ type query. The participant indicators 2325a-2325c may be used to indicate information of a participant associated with a response indicated in the GUI 2300. For example, the participant indicator 2325b may indicate that ‘Uzer’ has initiated a conversation with ‘Bob’ by asking ‘Why are you a Moss fan?’ indicated in the response indicator 2330b. The ‘Reply’ action control may cause a response entered by ‘Uzer’ to be added to a conversation as tracked in the GUI 2300.

While the user interfaces described herein have been illustrated using particular types and numbers of interface elements, no limitation is implied thereby, Any number and type of user interface elements as are well known in the art may be used to implement the functionalities described without departing from the scope and spirit of the embodiments described herein.

A system and method for engaging with users while a responder is obtained is described. When a request is received an automated response is determined. An automated response is delivered according to a pattern which emulates a human person responding to a request.

Using the method and systems described herein a user may be engaged during a time period when a requester is sought to respond to a request. If an automated response is found which matches a user request, a response is presented in a manner similar to a human person entering text. If an automated response is not found, a simulated preliminary response may be provided. For example, if a question is requesting objective information an automated response which would clarify a request, or which might be relevant to a request may be presented in a manner similar to that by which a human person would respond. For example text entry speed, correction of errors, and other similar features might be used to present a response to a requester while a human responder is obtained.

An automated resource which may be used to provide a preliminary response may be associated with an indicator of a user or avatar. If a requester elects to converse based on a response associated with a pseudonymous avatar, a responder associated with the avatar may conduct a conversation or interactive dialogue with a requester. An avatar associated with a resource may vary based on a topic, keyword, or category of a request or response.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method comprising:
receiving a request for information;
obtaining, by a processor, a response to the request for information; and
providing, by the processor, a user interface control which allows a source which activates the control to establish a communication channel with a person selected based on the response and a status assigned to a source of the response.

2. The method of claim 1 comprising:
establishing the communication as a real time link with a responder who has provided the response when the control provided in the user interface is activated and the responder is available for real time communication.

3. The method of claim 1 comprising:
establishing the communication channel with a human responder associated with a keyword of the response when the control provided is activated and the person who provided the response is not able to respond via the communication channel.

4. The method of claim 1 comprising:
selecting a human responder other than a source of the response based on the response;
providing an indicator of the human responder in the interface; and
establishing the communication channel with the human responder when the control is activated.

5. The method of claim 1 comprising:
selecting the response based on an availability of a source of the response to respond to the communication in real time.

6. The method of claim 1 comprising:
deactivating the control within a pre-determined time period subsequent to providing the control.

7. The method of claim 1 comprising:
delivering to a human responder the request when the human responder accepts to respond; and
including in an interface provided to the human responder a feature which allows the human responder to request a real time connection with a source of the request.

8. The method of claim 7 comprising:
establishing the real time connection prior to obtaining the response.

9. The method of claim 1 comprising:
obtaining the response based on stored information;
establishing the connection to a responder other than an originator of the response; and
selecting the responder based on a ranking of available responders for the originator.

10. The method of claim 9 comprising:
providing the request and the response to the responder when the responder is selected; and
selecting an answerer when the responder declines the request.

11. The method of claim 1 comprising:
providing the user interface control in an interface comprising requests and responses of sources to the requests; and
suppressing user interface controls which establish real time connections associated with sources of responses which are programmatic.

12. A system comprising:
a query distribution system comprising memory and a processor, receiving a request for information obtaining a response to the request for information, and providing a user interface control which allows a source which activates the control to establish a communication channel with a person selected based on the response and a status assigned to a source of the response.

13. The system of claim 12 comprising:
a user system submitting the request;
a requester system providing the user interface control, information of the request, the response and an originator of the request; and
a responder system establishing communication with the requester system when the user interface control is activated and the responder is available.

14. A non-transitory computer readable medium storing therein a program for causing a computer to execute an operation including creating media content, comprising:
receiving a request for information;
obtaining a response to the request for information; and
providing a user interface control which allows a source which activates the control to establish a communication channel with a person selected based on the response and a status assigned to a source of the response.

15. The computer readable storage medium of claim 14 wherein the operation further comprises:
obtaining the response based on stored information; and
presenting the response at the speed and error rate at which it was received from a person who has provided the stored information.

16. The computer readable storage medium of claim 14 wherein the operation further comprises:
obtaining the response based on stored information; and
presenting the response at the speed and error rate at which it was received from a person who has provided the stored information.

17. The computer readable storage medium of claim 14 wherein the operation further comprises:
selecting an a programmatic result as the response when the request is ambiguous; and
delivering the programmatic response at a rate which is determined based on a statistical analysis of rates at which responses are received from persons responding to requests.

18. The computer readable storage medium of claim 14 wherein the operation further comprises:
selecting images based on content of a stored answer which is determined to match the request;
delivering a low ranking image as an element the response; and
providing a higher ranking image as a portion of the response subsequent to delivering the low ranking image.

19. The computer readable storage medium of claim 14 wherein the operation further comprises:
selecting a pre-determined number of highest ranking text snippets based on the request; and
delivering the text snippets to the source of the request in an order based on the ranking when a person has not indicated that the person has accepted to respond to the request.

20. The computer readable storage medium of claim 14 wherein the operation further comprises:
distributing the request to a number of persons selected to respond to the request;
selecting a text snippet from a resource based on a ranking of the resource for the request;
delivering the text snippet to a source of the request at a rate which is determined based on an input speed and error level determined by the selected persons; and
including an error and a correction of the error in the delivering of the snippet.
